(19) United States
(12) Patent Application Publication
(10) Pub. No.: US 2026/0289301 A1
(43) Pub. Date: Sep. 24, 2026

(54) SYSTEM

(71) Applicant: SoftBank Group Corp., Tokyo (JP)

(72) Inventor: Hiroaki HASUIKE, Tokyo (JP)

(73) Assignee: SoftBank Group Corp., Tokyo (JP)

(21) Appl. No.: 19/567,017

(22) Filed: Mar. 14, 2026

(30) Foreign Application Priority Data
Mar. 19, 2025 (JP) 2025-045228

(51) Int. Cl. G06N 3/08; G06F 40/40; G06Q 30/018; G06V 10/25; G06V 10/764; G06V 10/77; G06V 10/82; G06V 20/52

(52) U.S. Cl. CPC G06N 3/08; G06F 40/40; G06Q 30/018; G06V 10/25; G06V 10/764; G06V 10/7715; G06V 10/82; G06V 20/52

(57) ABSTRACT

A system includes a processor that is configured to capture, by using a compact imaging device, images or video of dangerous areas in a work site, input, to a generative AI model, a first prompt that instructs the generative AI model to analyze the captured images or video to determine human behavioral patterns and emotional states, and obtain, from the generative AI model, an analysis result including the human behavioral patterns and the emotional states, and input, to the generative AI model, a second prompt that instructs the generative AI model to generate guidance including specific work procedures as countermeasures for identified dangerous areas and to adjust contents of the guidance according to the emotional states of workers, and obtain, from the generative AI model, guidance data including the specific work procedures adjusted based on the emotional states of the workers.

### CROSS-REFERENCE TO RELATED APPLICATION

This application is based on and claims priority under 35 USC 119 from Japanese Patent Application No. 2025-045228 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional safety management systems for work sites, such as construction sites or industrial plants, mainly focus on detecting physical hazards or checking compliance with equipment-related safety rules, for example, the presence of helmets or harnesses. However, these systems are generally unable to analyze human behavioral patterns and emotional states from captured images or video. As a result, conventional systems cannot provide safety guidance that is dynamically adapted to the psychological condition of workers, such as stress, fatigue, or agitation, which significantly influences the likelihood of human error and accidents. Furthermore, conventional systems do not leverage generative AI models to automatically generate detailed, context-aware work procedures and countermeasures for specific dangerous areas, and thus rely heavily on human supervisors to interpret risks and formulate instructions. Therefore, there is a need for a system that can automatically analyze human behavioral patterns and emotional states from captured images or video, evaluate workers' equipment conditions and safety standard compliance, and generate, via a generative AI model, specific countermeasures and work procedures that are adjusted according to the emotional states of workers, thereby improving safety and reducing the burden on human supervisors.

### SUMMARY

In order to solve the above-described problems, the present invention provides a system comprising a processor, wherein the processor is configured to capture, by using a compact imaging device, images or video of dangerous areas in a work site. The processor is further configured to input, to a generative AI model, a first prompt that instructs the generative AI model to analyze the captured images or video to determine human behavioral patterns and emotional states, and to obtain, from the generative AI model, an analysis result including the human behavioral patterns and the emotional states. The processor is also configured to input, to the generative AI model, a second prompt that instructs the generative AI model to generate guidance including specific work procedures as countermeasures for identified dangerous areas and to adjust contents of the guidance according to the emotional states of workers, and to obtain, from the generative AI model, guidance data including the specific work procedures adjusted based on the emotional states of the workers. In addition, the processor may be configured to input, to the generative AI model, a third prompt that instructs the generative AI model to analyze the captured images or video to evaluate equipment conditions of workers and determine whether the equipment conditions satisfy predetermined safety standards, and to obtain, from the generative AI model, an evaluation result indicating whether the predetermined safety standards are satisfied. The processor may further be configured to input, to the generative AI model, a fourth prompt that instructs the generative AI model to generate guidance that adjusts countermeasures for the identified dangerous areas based on the emotional states of the workers and provides appropriate safety measures, and to obtain, from the generative AI model, guidance data including the adjusted countermeasures and the appropriate safety measures. By these means, the system automatically provides context-aware and emotion-adaptive safety instructions and work procedures without requiring manual intervention by a human supervisor.

The term “system” refers to an apparatus or a combination of hardware and software components including at least one processor and, optionally, one or more imaging devices, storage devices, and communication interfaces, configured to perform the functions described in the claims.

The term “processor” refers to one or more hardware processing units, such as a central processing unit (CPU), a microprocessor, a graphics processing unit (GPU), or a dedicated accelerator, or any combination thereof, configured to execute instructions and thereby perform the described processing.

The term “compact imaging device” refers to a physically small camera or image sensor apparatus, such as a fixed camera, a wearable camera, or an IP camera, capable of capturing still images or video of a work site or a part thereof.

The term “work site” refers to any location in which work is performed by one or more workers, including but not limited to construction sites, factories, warehouses, plants, and maintenance or inspection locations.

The term “dangerous area” refers to a region within the work site in which there is an elevated risk of accidents, injuries, or other safety incidents, for example due to height, proximity to machinery, hazardous materials, or insufficient protective structures.

The term “captured images or video” refers to digital image data, including still images and sequences of frames, obtained by the compact imaging device during operation at the work site.

The term “human behavioral patterns” refers to observable actions or movement tendencies of one or more workers, such as posture, walking patterns, use of tools, interaction with equipment, or proximity to hazardous objects, as inferred from captured images or video.

The term “emotional states” refers to psychological or affective conditions of workers, including but not limited to stress, fatigue, anxiety, agitation, calmness, or concentration, which are estimated or inferred from captured images or video by analysis performed using the generative AI model.

The term “generative AI model” refers to a machine learning model, such as a large language model or a multimodal generative model, configured to generate text or other content in response to input prompts, and to perform analysis or reasoning based on such prompts and optionally on associated data.

The term “prompt” refers to an input instruction, request, or query, typically represented as text data, that is provided to the generative AI model in order to specify a processing objective, such as analysis of images or generation of guidance.

The term “first prompt” refers to a prompt that instructs the generative AI model to analyze captured images or video to determine human behavioral patterns and emotional states, and to output an analysis result including such patterns and states.

The term “second prompt” refers to a prompt that instructs the generative AI model to generate guidance including specific work procedures as countermeasures for identified dangerous areas and to adjust the contents of the guidance according to the emotional states of workers.

The term “third prompt” refers to a prompt that instructs the generative AI model to analyze captured images or video to evaluate equipment conditions of workers and to determine whether the equipment conditions satisfy predetermined safety standards.

The term “fourth prompt” refers to a prompt that instructs the generative AI model to generate guidance that adjusts countermeasures for identified dangerous areas based on the emotional states of workers and that provides appropriate safety measures.

The term “analysis result” refers to data output from the generative AI model in response to the first prompt, including information indicating human behavioral patterns and emotional states inferred from the captured images or video.

The term “guidance” refers to instructions, recommendations, or advice generated by the generative AI model for workers or supervisors, including but not limited to work procedures, safety measures, and behavioral recommendations.

The term “specific work procedures” refers to concrete, actionable steps or sequences of actions that workers are instructed to perform, such as how to enter or leave a dangerous area, how to use protective equipment, or how to perform tasks safely.

The term “guidance data” refers to structured or unstructured information, typically in textual form, output by the generative AI model in response to prompts, and representing generated guidance, including specific work procedures and adjusted countermeasures.

The term “equipment conditions of workers” refers to the state or presence of personal protective equipment and other safety-related gear worn or used by workers, such as helmets, safety glasses, gloves, harnesses, or protective clothing.

The term “predetermined safety standards” refers to one or more criteria or rules defining acceptable safety conditions, for example legal regulations, industry standards, or company safety policies, against which the equipment conditions of workers are evaluated.

The term “evaluation result” refers to output data generated by the generative AI model in response to the third prompt, indicating an assessment of whether the workers' equipment conditions satisfy the predetermined safety standards.

The term “countermeasures” refers to actions, procedures, or safety measures intended to reduce or eliminate risks in dangerous areas, such as requiring specific protective equipment, restricting access, installing barriers, or modifying work methods.

The term “appropriate safety measures” refers to countermeasures that are suitable for the identified dangerous area and for the emotional states and behavioral patterns of the workers, and that are expected to mitigate identified risks.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

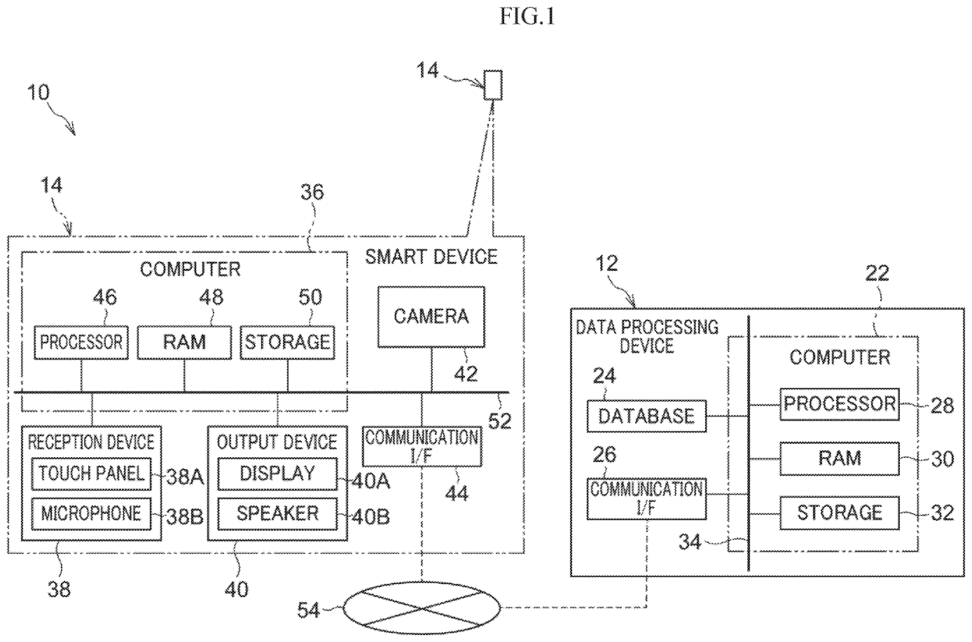

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

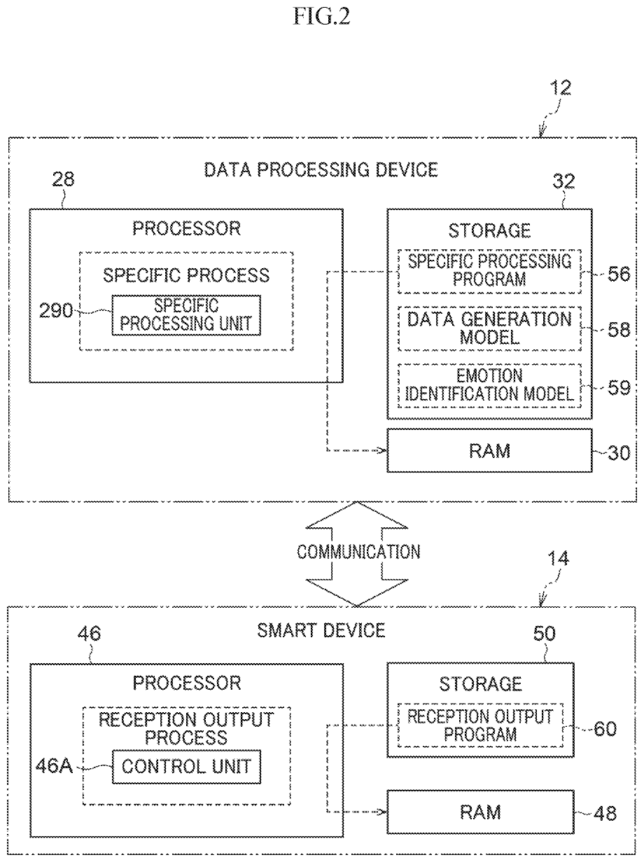

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional safety management systems for work areas, such as industrial sites and construction sites, typically rely on rule-based video analytics or manually predefined thresholds to detect dangerous situations. These systems are often configured to execute fixed image-processing pipelines on a computing device to detect the presence or absence of specific objects or events, and then issue alerts according to hard-coded rules. Such architectures exhibit several technical limitations from the viewpoint of computer technology.

First, conventional systems are not configured to flexibly interpret complex combinations of visual features, contextual information, and temporal patterns. When the number of rules and conditions grows, the processing logic executed by the processor becomes complicated, leading to increased computational overhead and degraded performance. The processor must evaluate many condition branches for each frame or event, which causes latency in real-time analysis and results in delayed notifications. Consequently, the computer resources are not efficiently utilized and the responsiveness of the system is impaired.

Second, conventional systems are not equipped to adapt their analysis and guidance generation according to diverse site conditions and worker states without extensive manual reprogramming. When a new type of work, equipment, or safety requirement is introduced, a system administrator must redesign detection algorithms or rewrite rule sets. This static nature of the processing logic makes it difficult to scale the system across different sites or to maintain it over time, and increases the risk of misdetection or missed detection when the pre-defined rules do not match the real-world conditions captured in image information.

Third, conventional guidance mechanisms typically output uniform messages that are not adjusted based on worker-specific state information, such as emotional or psychological state inferred from image information. As a result, the processor merely outputs generic alerts or instructions, which may not be effective for all workers or may even cause confusion or alarm. From a technical perspective, the system does not leverage available state information to dynamically tailor its output, and thus fails to optimize the interaction logic executed between the server, the terminal device, and the workers.

Fourth, when image information and analysis results are processed independently, the processor often has to perform multiple separate passes of computation to derive dangerous areas, generate alerts, and then manually compose guidance content. This fragmented processing causes redundant data transformations and increases memory access and communication overhead between software modules running on the server, thereby reducing overall throughput and scalability of the system.

Accordingly, there is a need for a system and server-side processing architecture that improves computer technology by: (i) efficiently transforming raw image information into structured feature information on a processor, (ii) using a generative AI model with prompt sentences as a flexible inference engine that integrates multiple types of data (visual features, safety standards, and worker states), (iii) automatically generating both dangerous area information and adaptive guidance content in a unified processing flow, and (iv) reducing the complexity of rule-based code while improving responsiveness, scalability, and robustness of the safety management computation executed by the server.

The specific processing by the specific processing unit 290 of the data processing device 12 in Example 1 is realized by the following means.

The present invention provides a server comprising a processor configured to control an imaging device to acquire and compress image information of a work area and to transmit the compressed image information via a communication network; to receive the compressed image information via the communication network, to decode the compressed image information into an analyzable format, and to extract feature information relating to workers and a work environment from the decoded image information; to generate descriptive information indicating candidate dangerous areas and risk factors on the basis of the extracted feature information, to generate a prompt sentence including the descriptive information and predetermined analysis conditions, to input the prompt sentence into a generative AI model, and to obtain, from the generative AI model, an analysis result relating to dangerous areas and risk levels in the work area; to identify a dangerous area on the basis of the analysis result and to record dangerous area information including position information, time information, and risk level information associated with the dangerous area, and to generate a notification message relating to the dangerous area and reference information indicating a portion of the image information; to transmit the dangerous area information including the notification message to a terminal device or a management device and to cause the terminal device or the management device to present contents of the dangerous area; to generate a further prompt sentence including the recorded dangerous area information and state information relating to a worker, to input the further prompt sentence into the generative AI model so as to cause the generative AI model to generate guidance content including a countermeasure method for the dangerous area and a work procedure corresponding to the countermeasure method, and to obtain the generated guidance content; and to transmit the obtained guidance content to the terminal device or the management device and to cause the terminal device or the management device to present the guidance content in accordance with the state information of the worker. This enables the server to implement an improved computer-implemented safety management process in which raw image information is efficiently converted into structured dangerous area information and adaptive guidance content by using prompt-based interaction with a generative AI model, thereby reducing the need for complex rule-based programming, lowering computational overhead for decision logic, improving responsiveness and scalability in real-time dangerous area detection, and dynamically tailoring safety instructions to worker-specific states within an integrated server-side processing architecture.

The term “system” refers to a combination of hardware and software components including at least one processor, memory, communication interfaces, and associated programs that are configured to execute the claimed functions.

The term “processor” refers to a hardware computing element, such as a central processing unit or a processing core, that executes machine-readable instructions to perform data processing, control, and communication operations.

The term “imaging device” refers to an apparatus configured to capture image information of a physical space, such as a camera or image sensor, which converts optical information from a work area into digital image data.

The term “work area” refers to a physical region in which one or more workers perform tasks, including but not limited to industrial, manufacturing, construction, or maintenance environments.

The term “image information” refers to digital data representing at least one image or a sequence of images of the work area captured by the imaging device.

The term “compressed image information” refers to image information that has been encoded using a data compression scheme in order to reduce data size for storage or transmission via a communication network.

The term “communication network” refers to a wired or wireless data communication infrastructure that enables transmission and reception of information between the server, the terminal device, the management device, and other components.

The term “terminal device” refers to an end-user computing device, such as a mobile device, tablet, wearable device, or personal computer, that is configured to receive information from the server and present the information to a user.

The term “management device” refers to a computing device used by supervisory personnel, such as a workstation, server, or client terminal, that is configured to receive, display, and manage dangerous area information and guidance content.

The term “decoded image information” refers to image information obtained by converting compressed image information back into an analyzable digital format suitable for further processing by the processor.

The term “feature information” refers to data derived from the decoded image information that characterizes at least one of a worker, an object, or the work environment, such as positions, shapes, motion patterns, or equipment states.

The term “worker” refers to a human individual performing a task within the work area, whose actions, positions, and states may be analyzed by the system.

The term “work environment” refers to physical conditions, objects, and structures present in the work area, including equipment, machinery, scaffolds, floors, and other surroundings that may influence safety.

The term “descriptive information” refers to textual or structured data generated on the basis of feature information that represents candidate dangerous areas, risk factors, and contextual conditions of the work area.

The term “candidate dangerous areas” refers to regions or locations in the work area that are preliminarily identified based on feature information as potentially presenting a safety risk.

The term “risk factors” refers to conditions or combinations of conditions, such as height, absence of protective equipment, proximity to hazardous objects, or unsafe postures, that may increase the likelihood or severity of an accident.

The term “prompt sentence” refers to a structured text input, including descriptive information and analysis conditions, that is provided to a generative AI model to request generation of an analysis result or guidance content.

The term “generative AI model” refers to a machine-learned model configured to generate textual or structured outputs in response to an input prompt sentence, by using learned representations derived from training data.

The term “analysis result” refers to output information produced by the generative AI model in response to a prompt sentence, including at least an evaluation of dangerous areas and associated risk levels.

The term “dangerous area” refers to a specific region or location within the work area that has been determined, based on the analysis result, to present a safety risk that may cause harm to a worker.

The term “risk level” refers to an indication of the severity or likelihood of a hazardous event occurring in a dangerous area, represented, for example, as qualitative or quantitative values.

The term “dangerous area information” refers to data associated with a dangerous area, including at least position information, time information, risk level information, and optionally related evaluation results or descriptive information.

The term “position information” refers to data indicating a spatial location of a dangerous area or an object in the work area, such as coordinates in an image frame or in a physical coordinate system.

The term “time information” refers to data indicating a temporal aspect associated with a dangerous area, such as a timestamp or time interval during which the dangerous area was identified.

The term “notification message” refers to information generated for transmission to a terminal device or a management device that indicates the presence, nature, or status of a dangerous area.

The term “reference information” refers to data that identifies or links to at least a portion of the image information, such as an image frame, snapshot, or video segment, associated with a dangerous area.

The term “state information” refers to data indicating at least one aspect of a worker's condition, including physical, behavioral, emotional, or psychological state inferred from image information or other inputs.

The term “guidance content” refers to information generated by the generative AI model that includes at least one countermeasure method and one work procedure for addressing a dangerous area.

The term “countermeasure method” refers to a recommended safety action or set of actions intended to reduce, mitigate, or eliminate a risk in a dangerous area.

The term “work procedure” refers to an ordered set of steps or operational instructions that a worker should perform in accordance with a countermeasure method.

The term “safety standard information” refers to data defining rules, criteria, or thresholds used to determine whether a worker's equipment usage or behavior complies with predetermined safety requirements.

The term “protective equipment” refers to personal protective articles worn or used by a worker to reduce injury risk, such as helmets, gloves, safety glasses, harnesses, or protective clothing.

The term “wearing state of protective equipment” refers to information indicating whether protective equipment is correctly worn, partially worn, or not worn by a worker, as recognized from image information.

The term “work position” refers to information indicating a spatial location or posture of a worker in the work area, including height, proximity to edges, or relation to objects or equipment.

The term “evaluation result” refers to output information indicating whether a safety standard is satisfied or violated, as determined by the generative AI model in response to a prompt sentence including safety standard information.

The term “emotional state” refers to information representing an inferred affective condition of a worker, such as stress, anxiety, calmness, or agitation, derived from image information or other signals.

The term “psychological state” refers to information representing an inferred mental condition of a worker, such as attention level, fatigue, or motivation, derived from image information or other signals.

The term “present” refers to cause a terminal device or a management device to display, output, or otherwise make accessible information, such as dangerous area information or guidance content, to a user.

The server, the terminal, and the user cooperate to implement embodiments of the invention as described below. Each embodiment can be realized by executing software modules on general-purpose computing hardware, and by deploying trained neural network models as part of a generative AI model system.

In one embodiment, the server is implemented as a computer system comprising at least one multi-core processor, a system memory, a storage device, a network interface, and optionally an accelerator device such as a graphics processing unit. The server runs an operating system such as a general-purpose server operating system and application software written in a high-level programming language such as C++, Java, or Python. The server uses image-processing libraries such as OpenCV and multimedia libraries such as FFmpeg to decode and preprocess image information, and uses machine learning frameworks such as TensorFlow or PyTorch to execute neural network models including the generative AI model.

The terminal is implemented as a mobile computing device, a tablet, a wearable device, or an embedded device that has a built-in or external imaging device. The terminal runs an operating system such as a mobile operating system or an embedded operating system and uses a camera control application programming interface to control the imaging device. The terminal uses a hardware video encoder included in a system-on-chip or a software encoder to compress captured image information into a streaming format such as H.264 or H.265. The terminal uses a communication stack to transmit compressed image information to the server over a communication network such as a wireless network or a wired network.

The user operates a management device, which may be a personal computer or a dedicated workstation, to monitor output from the server. The management device executes a client application or a web browser to communicate with the server, receive dangerous area information and guidance content, and present these items on a display. The user inputs commands or queries through an input device such as a keyboard, a mouse, or a touchscreen.

The server uses the imaging device to capture image information of a work area. The imaging device is, for example, a digital video camera, a network camera, or a camera module integrated in the terminal. The server, in some embodiments, remotely configures frame rate, resolution, exposure, and field of view parameters via a control protocol, thereby optimizing the amount and quality of image information sent to the server. The terminal compresses raw image frames using a video codec, and the server later decodes these frames with FFmpeg, thereby transforming them into arrays of pixel values stored in memory as image matrices.

The server performs feature extraction from decoded image information using a combination of deterministic algorithms and discriminative neural network models. For example, the server uses OpenCV to perform geometric transformations, color space conversions, and spatial normalization. The server then uses an object detection neural network such as a convolutional neural network with a feature pyramid structure to detect workers, protective equipment, scaffolds, edges, and other relevant elements in each frame. The object detection network comprises multiple convolutional layers, batch normalization layers, non-linear activation functions, and detection heads that output bounding boxes and class probabilities.

The server aggregates detection outputs over time to generate feature information that represents temporal patterns and spatial relationships in the work area. The server, for example, maintains a track table in memory, where each entry corresponds to a tracked worker and includes fields such as worker identifier, position coordinates in image space, estimated physical height, estimated distance to an edge, and an indicator of whether protective equipment such as a helmet is detected. The server updates this track table by associating detections in consecutive frames with existing tracks using a data association algorithm, such as a Hungarian algorithm or a Kalman filter-based tracker.

The server, after extracting such feature information, generates descriptive information that summarizes candidate dangerous areas and risk factors. The server constructs textual descriptions based on rules that map specific combinations of features to natural language. For example, if a worker is tracked at an estimated height above a threshold and a helmet is not detected with confidence above a predetermined probability, the server generates descriptive information such as “Worker A is on a high platform without a helmet and is close to an unguarded edge.” The server collects these descriptions for multiple workers and areas in the work area and forms a structured representation in memory.

The server generates a prompt sentence to be input into the generative AI model. The generative AI model is implemented as a neural network model, for example, a transformer-based language model trained on a large corpus of text and fine-tuned on safety-related instructions and site descriptions. The server provides to the generative AI model, as input, a prompt sentence that includes descriptive information and predetermined analysis conditions. An example of such a prompt sentence is:
“You are a safety management assistant. Analyze the following detected facts from construction site video: Worker #1 is standing on scaffolding approximately 5 meters above ground without a safety helmet and near an open edge. Worker #2 and Worker #3 are on ground level with helmets. Identify any dangerous zones, assign a risk level (low, medium, high), explain your reasoning, and recommend immediate safety measures in bullet points.”

The server, by constructing this prompt sentence, causes the generative AI model to perform integrated reasoning over multiple feature types. The generative AI model internally uses multi-head attention mechanisms to relate terms describing workers, heights, protective equipment, and edges. The model multiplies input token embeddings by learned weight matrices, computes attention scores, and aggregates contextualized embeddings across layers, thereby producing a sequence of output tokens that represent an analysis result. The server receives these output tokens via the machine learning framework and decodes them into a textual analysis result including identified dangerous areas and associated risk levels.

The server parses the textual analysis result using a parsing module, which may include regular expression rules or a lightweight natural-language understanding model, to extract structured information such as risk categories, zone descriptions, and recommended actions.

The server then identifies dangerous areas by mapping textual references back to the track table and image coordinates. The server constructs dangerous area information as a data structure held, for instance, in a relational database table with columns for position information, time information, risk level information, and identifiers to related snapshots. This specific data structure enables efficient querying, indexing by time and camera, and association with past incidents.

The server generates notification messages including dangerous area information and reference information pointing to stored image frames or video segments. The server, for example, generates a text notification such as “High-risk dangerous area: Worker without helmet on 5 m scaffold near open edge at 10:23:45,” and associates it with a Uniform Resource Identifier of an image snapshot. The server transmits this notification message to the terminal or the management device by using a messaging protocol such as HTTPS or a push notification protocol.

The user, via the management device, views dangerous area information and can confirm or investigate the details. The management device displays dangerous areas overlaid on images, thereby allowing the user to visually identify the specific region of concern. This visualization is not merely a presentation of data but is supported by the server's prior data transformation, in which high-dimensional pixel data has been translated into semantically meaningful, structured dangerous area information.

The server also generates a further prompt sentence that includes dangerous area information and state information related to a worker. The state information may include an inferred emotional state or psychological state, estimated from additional neural network models that analyze facial expressions, posture, or motion variability. Such a model, for instance, may be a recurrent neural network or a transformer-based sequence model that processes sequences of skeletal keypoints extracted from the worker's image over time.

The further prompt sentence is constructed in a similar manner and may be, for example:
“Given that a worker was detected working on a 5-meter-high scaffold without a safety helmet and appears to be under stress based on posture and motion analysis, generate detailed guidance consisting of immediate safety measures and step-by-step work procedures that are tailored to a stressed worker and that reduce the risk of falling or head injury.”

The generative AI model, when provided with this further prompt sentence, generates guidance content including a countermeasure method and a work procedure corresponding to the countermeasure method. The server obtains this guidance content and stores it as structured text. The server then transmits the guidance content to the terminal or the management device and causes the device to present the guidance content according to worker state information. For example, if a worker appears stressed, the system may choose a version of the guidance content that uses concise language and minimizes simultaneous instructions.

The server improves computer technology in several ways. The server, by using feature extraction and prompt generation prior to invoking the generative AI model, reduces the dimensionality and noise of the input to the generative AI model. This pre-processing results in fewer required tokens and a smaller computational burden for the generative AI model, which improves inference speed and reduces memory usage. The server, by structuring dangerous area information in a specific data schema, reduces redundant computations and enables sharing of analysis results across multiple modules without repeated feature extraction.

The server, by replacing a large set of hand-coded rules with a combination of feature-based descriptors and prompt-driven generative reasoning, reduces the complexity of branching logic, which simplifies control flow in the program and can reduce instruction cache pressure on the processor. The server can adapt to new work environments or safety rules by modifying prompt sentences or configuration tables without recompiling or redeploying core detection code, thereby achieving more scalable and maintainable software architecture.

The server further improves accuracy of dangerous area detection by combining discriminative models (such as object detectors and pose estimators) with a generative AI model that can interpret context, sequential patterns, and interactions between multiple workers. This hybrid approach allows the server to distinguish between visually similar situations (for example, a worker near an edge with proper protection versus without protection) by considering higher-level semantics encoded in the generative AI model. As a result, false positives and false negatives can be reduced compared with purely rule-based or purely low-level feature approaches.

In some embodiments, the server trains the generative AI model and other neural network models offline using supervised or semi-supervised learning. The server or a separate training system uses training data that includes labeled dangerous area examples and associated guidance instructions. The training method uses an error function, such as cross-entropy loss for classification labels and token-level loss for generated sequences, and updates model weights via gradient-based optimization algorithms. The training data may be augmented by synthetic transformations of image information, such as rotation, scaling, and color jitter, and by paraphrasing of prompt sentences to improve robustness of the generative AI model to diverse input phrasing.

The server, in certain variants, executes a safety standard evaluation pathway. In this pathway, the server includes in the prompt sentence information relating to a wearing state of protective equipment and a work position of a worker, as well as safety standard information.

The generative AI model outputs an evaluation result indicating whether safety standards are satisfied. This evaluation result is recorded in association with dangerous area information and can be used for subsequent analytics or for adjusting thresholds. By offloading the complex safety standard reasoning to the generative AI model, the server reduces the need for large, hard-coded rule sets, thereby enhancing maintainability and adaptability.

The terminal, in an alternative embodiment, is configured to present local warnings when the server indicates a dangerous area in the field of view of the terminal. The terminal may display a simple alert message and may output an audio or haptic signal. This direct interaction between server computation and terminal behavior demonstrates a technical use of the computed dangerous area information to affect device operation in the real world, beyond abstract data manipulation.

The system, in yet another embodiment, supports alternative generative AI model architectures, such as encoder-decoder transformers, mixture-of-experts models, or models specialized for safety reasoning. The server can select an appropriate generative AI model based on latency and accuracy requirements and can adjust parameters such as beam width, temperature, and maximum output length to control the balance between determinism and richness of generated content.

The system can be varied in many further ways while remaining within the scope of the claims. For example, the server can run on a cloud-computing infrastructure, while the terminal and the management device operate on-premises. Alternatively, the server can be deployed at the edge, closer to the work area, to reduce communication latency. The terminal can be replaced by a wearable device such as smart glasses, allowing workers to see guidance content overlaid on their field of view. The feature extraction models may use different types of neural network architectures, such as graph neural networks for modeling relationships between workers and objects. The generative AI model can be integrated with a rules module that enforces hard safety constraints on the guidance content.

By configuring the server, the terminal, and the user interaction in this manner, the embodiments of the invention provide a computer-implemented safety management system that not only automates aspects of human analysis but also improves core computer processing by optimizing data flow, reducing rule complexity, enhancing inference accuracy, and enabling dynamic, context-sensitive use of a generative AI model through carefully designed prompt sentences and structured feature information.

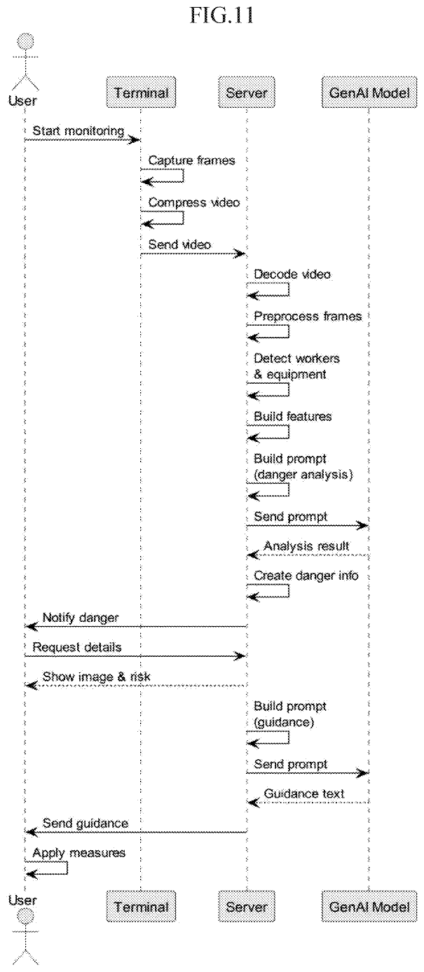

The following describes the processing flow using FIG. 11.

### Step 1:

The terminal initializes an imaging device and acquires raw image data.
Input: configuration parameters for frame rate, resolution, and exposure; control commands from the server or a local application.
Output: a sequence of raw image frames representing the work area.
The terminal uses a camera control API to set the frame rate (for example, 30 fps), resolution (for example, 1920×1080), and exposure settings on the imaging device. The terminal then starts a capture loop that reads raw frames from the camera sensor in a format such as YUV or RGB. The terminal timestamps each frame using a system clock and stores the frames in a temporary buffer in memory. The terminal may apply basic filtering, such as discarding blank or corrupted frames, before passing them to the next processing stage.

### Step 2:

The terminal compresses the raw image frames and prepares them for transmission.
Input: a sequence of raw image frames with timestamps.
Output: a compressed video stream segmented into packets with metadata.
The terminal invokes a hardware or software video encoder to convert raw frames into a compressed stream using a codec such as H.264 or H.265. The terminal sets encoder parameters such as bitrate, keyframe interval, and compression profile based on network conditions. The terminal divides the compressed byte stream into packets and attaches metadata fields, including camera identifier, frame timestamp, and, if available, location information. The terminal stores the packets in a send queue, ready for transmission over a communication network.

### Step 3:

The terminal transmits the compressed video packets to the server over a communication network.
Input: a queue of compressed video packets with metadata.
Output: transmitted packets delivered to the server via a network connection.
The terminal establishes a network session with the server using a transport protocol such as TCP over a higher-level protocol such as HTTPS or RTSP. The terminal sends packets sequentially, monitoring acknowledgment responses or socket status to detect transmission failures. The terminal retransmits packets or adjusts sending rate when network congestion or packet loss is detected. The terminal continues this process as long as the imaging device is capturing frames.

### Step 4:

The server receives and decodes the compressed video packets into analyzable image frames.
Input: compressed video packets received from the terminal.
Output: decoded image frames stored as pixel matrices in memory.
The server listens on a designated port and accepts incoming connections from the terminal. The server reconstructs the compressed byte stream from the received packets, verifying packet order and integrity. The server uses a multimedia library to decode the compressed stream into individual frames, each represented as a matrix of pixel values in RGB or another appropriate color space. The server stores these frames in a frame buffer together with associated timestamps and camera identifiers. The server discards or marks incomplete frames that cannot be decoded correctly.

### Step 5:

The server preprocesses the decoded image frames for feature extraction.
Input: decoded image frames with timestamps and camera identifiers.
Output: normalized and resized image tensors ready for neural network input.
The server, for each frame, resizes the pixel matrix to a fixed resolution (for example, 640×360) and converts the color space if necessary (for example, BGR to RGB). The server normalizes pixel values to a standardized range (for example, 0 to 1 or −1 to 1) and arranges them into tensors with shape corresponding to batch size, channels, height, and width. The server groups several consecutive frames into batches to optimize throughput on a processor or accelerator. The server stores these tensors in memory, associating them with metadata for later mapping between features and image locations.

### Step 6:

The server extracts low-level and mid-level features from the image tensors using deterministic algorithms and discriminative models.
Input: preprocessed image tensors with associated metadata.
Output: per-frame feature sets including detected entities and their attributes.
The server uses an image-processing library to compute basic features, such as edges, motion indications between consecutive frames, or background segmentation masks. The server then feeds the image tensors into an object detection network and a pose estimation network. These networks compute convolutional feature maps, apply non-linear activations, and produce bounding boxes, class labels (for example, worker, scaffold, helmet), and confidence scores. The server calculates derived attributes, such as estimated worker height above ground, distance to an edge, and whether a bounding box of a helmet overlaps with a bounding box of a worker's head. The server outputs feature records for each detected entity in each frame.

### Step 7:

The server aggregates features over time to maintain tracks and build structured feature information.
Input: per-frame feature sets including detected workers and objects.
Output: track-level feature information describing workers' positions, equipment states, and movements.
The server maintains a tracking table where each row corresponds to a tracked worker. Using a data association algorithm, the server links new detections in the current frame to existing tracks based on spatial proximity, appearance similarity, and motion predictions. The server updates each track with current coordinates, bounding box dimensions, equipment detection flags, and derived metrics such as time spent at a specific height or near a hazard. The server creates new track entries when a new worker appears and removes or deactivates tracks when a worker leaves the field of view. The server outputs a consolidated feature set that describes the status of each tracked worker and relevant environmental objects over a recent time window.

### Step 8:

The server generates descriptive information representing candidate dangerous areas and risk factors.
Input: track-level feature information for workers and work environment objects.
Output: textual descriptive information for each candidate dangerous area.
The server applies rule-based mapping from numerical features to natural language descriptors. For example, when a worker's estimated height exceeds a threshold and the helmet detection flag is false, the server generates a sentence such as “Worker #1 is working on a high platform (about 5 meters) without wearing a safety helmet.” When a worker is close to an unguarded edge, the server adds “and is near an open edge with no visible guardrail.” The server groups related descriptions of workers and objects in the same region and forms a narrative description of a candidate dangerous area. The server stores this descriptive information along with identifiers of associated tracks and image locations.

### Step 9:

The server constructs a prompt sentence for a generative AI model based on descriptive information and analysis conditions.
Input: descriptive information for candidate dangerous areas and predefined analysis conditions or safety rules.
Output: a prompt sentence prepared for input to the generative AI model.
The server combines descriptive sentences with explicit instructions specifying the required analysis. For example, the server builds a prompt sentence such as:
“You are a safety management assistant. Analyze the following detected facts from construction site video: Worker #1 is standing on scaffolding approximately 5 meters above ground without a safety helmet and near an open edge. Worker #2 and Worker #3 are on ground level with helmets. Identify any dangerous zones, assign a risk level (low, medium, high), explain your reasoning, and recommend immediate safety measures in bullet points.”
The server appends additional constraints, such as desired output format or maximum number of recommendations, to the prompt sentence. The server creates a text string in a character encoding suitable for the generative AI model API.

### Step 10:

The server transmits the prompt sentence to the generative AI model and obtains an analysis result.
Input: a prompt sentence containing descriptive information and analysis conditions.
Output: a textual analysis result describing dangerous areas and risk levels.
The server sends the prompt sentence to a generative AI model service via an API call over a communication protocol such as HTTPS. The generative AI model processes the prompt by tokenizing the text, mapping tokens to embeddings, and applying multiple transformer layers with attention mechanisms and feed-forward networks. The model produces a sequence of output tokens that the server receives as a text response. The analysis result typically includes identification of dangerous zones, assignment of risk levels, explanatory reasoning, and initial suggestions for countermeasures. The server stores this output text in memory for further processing.

### Step 11:

The server parses the analysis result and identifies confirmed dangerous areas.
Input: the textual analysis result generated by the generative AI model.
Output: structured dangerous area information including position, time, and risk level.
The server uses parsing routines to extract structured elements from the text. For example, the server detects phrases indicating “high risk” or “medium risk” and aligns them with described workers or locations. The server maps these references back to track identifiers and image coordinates stored in the feature and track tables. The server creates dangerous area records that include position information (for example, bounding box or region coordinates), time information (for example, time window during which the danger was observed), and risk level information. The server stores these records in a database table with indexes on time and camera identifiers to allow efficient retrieval.

### Step 12:

The server generates notification messages with dangerous area information and reference information to image data.
Input: dangerous area records with position, time, and risk level, and pointers to image frames.
Output: notification messages ready for transmission to the terminal and the management device.
The server composes text messages summarizing each dangerous area, such as “High-risk dangerous area detected: Worker without helmet on 5-meter scaffold near open edge at 10:23:45.” The server generates or selects a representative image snapshot by extracting a frame from the video at the relevant timestamp and overlaying bounding boxes or markers around the dangerous area with an image-processing library. The server includes a link or identifier for this snapshot as reference information in the notification message. The server formats the message according to the protocol used for delivery, such as a JSON payload for a push notification or a text body for an email.

### Step 13:

The server transmits the notification messages to the terminal and the management device.
Input: formatted notification messages containing dangerous area summaries and reference information.
Output: delivered notifications appearing on terminal and management device interfaces.
The server selects target devices based on configuration and risk level, and sends the messages via communication channels such as push notification services, WebSocket connections, or email servers. The server manages delivery status, retries failed transmissions when necessary, and logs each notification in a communication log. The terminal and the management device receive these notifications and pass them to user-interface modules for display.

### Step 14:

The user reviews dangerous area information and responds with appropriate actions.
Input: displayed notifications and dangerous area details on the management device or terminal.
Output: user decisions, acknowledgments, and optionally updated instructions to workers.
The user reads the summary text and views the associated snapshot or video clip. The user interprets the highlighted regions and the description of risk level. The user may acknowledge the alert in the management application, trigger follow-up actions such as contacting on-site supervisors, or record a response note. The user's interactions may be logged by the server for later analysis of response time and effectiveness.

### Step 15:

The server constructs a further prompt sentence for guidance content generation based on dangerous area information and worker state information.
Input: dangerous area records, evaluation results regarding safety standards, and worker state information.
Output: a further prompt sentence intended to obtain tailored guidance content from the generative AI model.
The server retrieves dangerous area information and, if available, safety standard evaluation results and inferred worker emotional or psychological states. The server converts these data items into descriptive text, such as “The worker is stressed and is working without a helmet on a high scaffold.” The server embeds these descriptions into a prompt sentence such as:
“Given that a worker was detected working on a 5-meter-high scaffold without a safety helmet and appears to be under stress based on posture and motion analysis, generate detailed guidance consisting of immediate safety measures and step-by-step work procedures that are tailored to a stressed worker and that reduce the risk of falling or head injury.”
The server ensures that the prompt clearly specifies the desired output structure, such as numbered steps or bullet points.

### Step 16:

The server sends the further prompt sentence to the generative AI model and obtains guidance content.
Input: a further prompt sentence containing dangerous area and worker state descriptions.
Output: textual guidance content including countermeasure methods and work procedures.
The server calls the generative AI model API again, providing the further prompt sentence as input. The generative AI model processes the prompt and outputs text that includes explicit countermeasure methods, such as “stop work immediately,” “ensure helmet is properly worn,” and “install temporary guardrails,” along with ordered work procedures for implementing these measures. The server receives the generated text and stores it as guidance content in a guidance database or cache.

### Step 17:

The server selects and formats guidance content for presentation according to worker state information.
Input: raw guidance content from the generative AI model and worker state information.
Output: filtered and formatted guidance content suitable for display on the terminal or the management device.
The server evaluates the guidance content against worker state information and system policies. For example, if a worker is inferred to be stressed, the server selects simplified instructions and avoids overly complex or lengthy text. The server might split long procedures into smaller segments or reorder steps to highlight the most critical safety actions first. The server formats the guidance into a display-friendly structure, such as numbered lists or short paragraphs, and associates the content with the corresponding dangerous area record.

### Step 18:

The server transmits the formatted guidance content to the terminal or the management device, and the user or local supervisor implements the recommended measures.
Input: formatted guidance content and device addresses or user identifiers.
Output: presented guidance on display devices and subsequent user or supervisor actions.
The server sends the guidance content to the selected device using the same or similar communication channels as used for notifications. The terminal or management device displays the instructions, possibly alongside the dangerous area visualization. The user or a local supervisor reads the guidance, communicates specific instructions to workers on-site, and may confirm implementation within the application. These confirmations are sent back to the server, where they are recorded alongside the original dangerous area records, enabling further analysis of how guidance content correlates with risk mitigation outcomes.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional safety management systems for work areas often rely on simple rule-based detection mechanisms or static alert thresholds that operate on limited sensor inputs. Such systems typically perform object detection or zone monitoring in isolation and raise predefined alarms without adapting to complex scene context or user needs. As a result, these systems suffer from several technical limitations in terms of computer technology.

First, existing systems frequently process image streams and generate alerts in separate subsystems, requiring manual integration between vision modules and advisory modules. This fragmented architecture increases latency, reduces throughput, and makes it difficult to maintain consistent data structures across the pipeline from video ingestion to user notification.

Second, conventional computer-implemented safety solutions often lack a unified mechanism to convert structured machine-readable hazard data into dynamically generated, context-aware natural language guidance. In many systems, advisory messages are hard-coded or generated from rigid templates that do not leverage the full semantic richness of the detected hazards. This results in repetitive or overly generic alerts that do not scale well to diverse scenarios or evolving worksite conditions.

Third, most existing safety management platforms do not provide an integrated dialogue loop between users and the underlying analysis components. User responses, clarifications, or feedback are rarely re-incorporated into the computational pipeline in real time. Consequently, the system cannot adapt its advising behavior based on user interaction, and the computational resources devoted to machine learning models and natural language generation are underutilized.

Fourth, it is technically challenging to design a computer system that efficiently coordinates high-volume video analysis, structured hazard event generation, prompt sentence construction for a generative AI model, and distribution of guidance to heterogeneous user devices, all while maintaining low latency and system scalability. Without an architecture that tightly couples these components, the system may experience bottlenecks in video processing, inconsistencies between detected hazards and advisory messages, and difficulties in managing multi-device, real-time notifications.

Accordingly, there is a need for an improved computer-implemented system and method that: (i) automatically converts streaming image information into structured hazard representations using machine learning models; (ii) constructs prompt sentences that seamlessly integrate the structured information into instructions for a generative AI model; (iii) generates adaptive, context-aware guidance information in natural language; and (iv) supports interactive dialogue with users so that subsequent guidance can be refined based on prior outputs and user responses. The technical problem addressed by the present invention is to improve the overall computer system architecture and data processing flow so that hazard detection, natural language guidance generation, and user interaction are integrated into a coherent, low-latency, and scalable pipeline.

The specific processing by the specific processing unit 290 of the data processing device 12 in Application Example 1 is realized by the following means.

The present invention provides a server comprising a processor configured to receive, via a communication interface, image information transmitted from an imaging device that captures a state of a work area, store the image information in a storage device, perform object detection processing and region determination processing on the image information by using a machine learning model to detect workers, protective equipment, moving bodies, fall locations, restricted areas, and other targets, and generate structured information indicating hazardous regions and hazardous actions based on detection results; a prompt generation module executed by the processor and configured to format text information including the structured information into a natural language instruction sentence, generate a prompt sentence to be input to a generative AI model, and instruct the generative AI model to generate safety measures and work procedures; a guidance generation module executed by the processor and configured to acquire advice information in natural language output from the generative AI model, format the advice information as guidance information including specific countermeasures and work instructions corresponding to the hazardous regions and the hazardous actions, and notify the guidance information, via a communication interface, to a portable information terminal device or a visual presentation device; and a dialogue processing module executed by the processor and configured to acquire response information or inquiry information of a user from the portable information terminal device or the visual presentation device, generate an additional input prompt sentence including the response information or the inquiry information, the guidance information generated in the past, and the structured information, input the additional input prompt sentence to the generative AI model, and cause the generative AI model to generate updated guidance information based on the additional input. This enables an integrated computer-implemented pipeline that transforms streaming image data into machine-interpretable hazard representations, automatically generates context-aware natural language guidance via prompt sentences to a generative AI model, and adaptively refines subsequent guidance through interactive dialogue with users, thereby improving system-level latency, scalability, and consistency in safety-related information processing.

The term “work area” refers to a physical environment in which tasks such as construction, manufacturing, maintenance, or logistics operations are performed and in which safety management and hazard monitoring are required.

The term “imaging device” refers to an apparatus configured to capture image information of a scene, including but not limited to a camera, a video camera, or a sensing device with an image sensor capable of outputting still images or moving images.

The term “image information” refers to digital data representing visual content of a scene, including sequences of frames, still images, or encoded video streams suitable for processing by an information processing apparatus.

The term “communication device” refers to hardware and associated control logic that enable data transmission and reception between the imaging device, the server, and terminal devices over a wired or wireless communication network.

The term “storage device” refers to a hardware component or subsystem, such as a memory or a non-volatile storage medium, configured to store image information, structured information, guidance information, and related data.

The term “information processing apparatus” refers to a computing system including at least one processor and memory, configured to execute software for processing image information, performing machine learning inference, constructing structured information, and controlling communication with other devices.

The term “machine learning model” refers to a computational model trained on data to perform tasks such as object detection or region classification, including models implemented by neural networks or other statistical learning algorithms.

The term “object detection processing” refers to computational processing that analyzes image information to identify and localize target objects, such as workers, protective equipment, moving bodies, or environmental features, and to output identifiers and positional data for the detected objects.

The term “region determination processing” refers to computational processing that identifies specific areas within image information, including hazardous regions, restricted areas, or zones associated with particular risk levels, based on detection results or preconfigured spatial information.

The term “workers” refers to persons present in the work area who perform tasks or operations and whose actions or safety conditions are subject to monitoring by the system.

The term “protective equipment” refers to safety-related items worn or used by workers, such as helmets, safety glasses, gloves, harnesses, or other personal protective gear intended to reduce the risk of injury.

The term “moving bodies” refers to physical entities capable of movement within the work area, including vehicles, machines, robots, or other mobile equipment that can pose safety risks.

The term “fall locations” refers to locations or regions within the work area where there is a risk of a person or object falling, such as edges, openings, elevated platforms, or stairways without sufficient protective barriers.

The term “restricted areas” refers to zones within the work area where access is limited or prohibited due to safety, operational, or regulatory reasons, and where presence of workers may constitute a hazardous condition.

The term “hazardous regions” refers to spatial areas identified within the work area where a risk of accident, injury, or unsafe condition is determined to exist based on detection results and predefined criteria.

The term “hazardous actions” refers to behaviors or activities of workers or moving bodies within the work area that increase the likelihood of accidents or safety incidents, as determined by analysis of detection results and contextual information.

The term “structured information” refers to data representing hazardous regions and hazardous actions in a machine-readable format, including attributes such as object types, positions, timestamps, risk levels, and relationships among detected entities.

The term “generative AI model” refers to an artificial intelligence model configured to receive prompt sentences as input and generate natural language output, such as safety measures, work procedures, or advisory messages, based on learned patterns.

The term “prompt sentence” refers to a text sequence formatted as an instruction or query in natural language and including structured information or contextual data, the text sequence being used as input to the generative AI model to request generation of guidance information.

The term “prompt generation module” refers to a functional component executed by the processor and configured to construct, format, and output prompt sentences for input to the generative AI model.

The term “guidance information” refers to natural language information generated based on the output of the generative AI model, including specific countermeasures, work instructions, safety measures, or procedural steps associated with hazardous regions and hazardous actions.

The term “portable information terminal device” refers to a mobile computing device capable of wireless communication and display, such as a handheld terminal, a smartphone, or a tablet, that presents guidance information to a user.

The term “visual presentation device” refers to a device configured to present visual information to a user, including head-mounted displays, smart glasses, or other display apparatuses that can show guidance information or hazard indications.

The term “advice information” refers to natural language output generated by the generative AI model in response to a prompt sentence, the output describing safety measures, recommendations, or work procedures.

The term “response information” refers to data representing a user's reaction or acknowledgement to guidance information, including confirmations, status updates, or selections entered via a terminal device.

The term “inquiry information” refers to data representing questions or requests for additional explanation or instructions input by a user through a terminal device and intended to obtain further guidance from the generative AI model.

The term “additional input prompt sentence” refers to a prompt sentence constructed to include response information or inquiry information together with structured information and prior guidance information, and used to request updated output from the generative AI model.

The term “dialogue processing module” refers to a functional component executed by the processor and configured to manage interactive exchanges between a user and the generative AI model, including generation of additional input prompt sentences and handling of updated guidance information.

In one embodiment, a server implements the claimed system by executing software components on a hardware platform that includes at least one central processing unit (CPU), at least one graphics processing unit (GPU), a main memory, a non-volatile storage device, and a network interface. The server runs an operating system such as a general-purpose server operating system and provides network-accessible functions for image acquisition, hazard analysis, prompt generation, communication with a generative AI model, and notification delivery to terminals.

The server uses one or more imaging devices deployed in a work area. Each imaging device includes an image sensor, an image signal processor, and a communication interface such as a wired Ethernet interface or a wireless communication module. The server configures each imaging device to transmit encoded video streams, for example using a video coding method such as H.264, over a streaming protocol such as RTSP or over HTTP. The server receives the encoded video data through the network interface and stores the data in the storage device as a sequence of frames together with associated metadata including timestamps and camera identifiers.

The server uses a media processing library such as a general-purpose video processing library to decode the encoded video frames into raw pixel data. The server represents each frame as a multidimensional array of pixel values in a numerical computing framework. The server resizes each frame to a predetermined resolution, for example 640×640 pixels, and normalizes pixel values to a predefined range. The server converts the frame arrays into tensors compatible with a neural network framework and transfers the tensors to the GPU memory via a device driver interface.

The server executes an object detection model that is a convolutional neural network configured with multiple convolution layers, activation layers, down-sampling layers, and detection heads. The server may use a model architecture that utilizes residual connections, feature pyramids, and anchor-based or anchor-free detection mechanisms. The server pre-trains this model using a supervised learning procedure in which the server minimizes a loss function that is a combination of localization error (for example, bounding box regression loss), classification error (for example, cross-entropy loss), and objectness error. During training, the server augments the training data by applying transformations such as random scaling, cropping, flipping, and color perturbation to increase robustness to variation in the work area. The server updates the model weights by applying a gradient-based optimization algorithm such as stochastic gradient descent with momentum or an adaptive learning rate optimizer. After training, the server stores the model parameters in the storage device and loads them into memory at runtime.

The server applies this trained object detection model to the preprocessed frames on the GPU. The server obtains, for each frame, a set of detections containing bounding box coordinates, category scores, and confidence values for targets such as persons, protective equipment, moving equipment, edges, openings, and markers indicating restricted zones. The server executes a non-maximum suppression algorithm on the CPU or GPU to eliminate overlapping detections that likely correspond to the same physical object. The server then maps the pixel coordinates of the detections to spatial regions defined in a configuration database that associates image coordinates or camera geometry with physical zones in the work area.

The server determines hazardous regions and hazardous actions by applying rule logic to the detection results. For example, the server identifies a missing protective equipment hazard when the server detects a person but does not detect a corresponding protective equipment category in a spatial region above the detected head area for that person. The server identifies a proximity hazard when the server detects both a person and a moving equipment object whose bounding boxes are separated by fewer than a predetermined number of pixels corresponding to a physical distance threshold. The server identifies a restricted area violation when the server detects a person in a region that the configuration database defines as a restricted zone. These rules are implemented as computations over the structured detection outputs, rather than as mere textual business rules, and leverage geometric relationships and temporal continuity across frames.

The server structures the hazard information in a machine-readable format by composing records that include fields for hazard type, associated detected objects, spatial location identifiers, timestamps, and a computed risk score. The server computes the risk score based on parameters such as object type, relative distance, duration of the hazard, and prior incident statistics. The server may map continuous risk values to discrete levels such as low, medium, or high. The server stores these hazard records in a data store optimized for time-series or event data, thereby improving data management by enabling efficient retrieval of hazard histories and correlation between events.

The server generates prompt sentences for a generative AI model by using a prompt generation module. The server maintains a prompt template for safety guidance such as:
“From the following hazard detection results, identify all dangerous regions and dangerous actions and generate specific corrective guidance for the on-site supervisor. Use clear, concise English suitable for immediate action. Detected hazards: [hazard list].”

The server replaces placeholders in the template with the structured hazard records. For example, the server inserts textual descriptions such as “a worker without a safety helmet on scaffolding third floor east side” or “a powered industrial vehicle moving within 0.5 meters of a pedestrian pathway.” The server constructs the resulting prompt sentence as a text string and sends it, via a secure network protocol, to a generative AI model endpoint.

The server uses a generative AI model that is a transformer-based neural network with an encoder-decoder or decoder-only architecture. The server configures the model with multiple self-attention layers, feed-forward layers, and layer normalization. During an offline training process, the server trains the model on a large corpus of text that includes safety-related descriptions and procedural instructions. The server applies a sequence modeling objective such as next-token prediction with a cross-entropy loss function and updates the model parameters using a gradient-based optimization method. The server may fine-tune the model further on domain-specific data containing hazard descriptions and safety manuals, thereby improving the precision and relevance of generated guidance.

The server provides the prompt sentence and optional system-level instructions to the generative AI model. The generative AI model processes the input token sequence using its attention mechanism, computing internal representations that capture relationships between hazard events, locations, and required actions. The server receives output tokens representing a natural language response and reconstructs the response as advisory text. For example, the server may receive text such as:
“The worker on the third-floor east-side scaffolding is not wearing required head protection. Immediately instruct the worker to stop work, move to a safe area, and put on certified head protection before resuming operations. Verify compliance visually and record the corrective action.”

The server formats this advisory text as guidance information by adding metadata such as hazard identifiers, severity level, and applicable time window. The server stores the guidance information in association with the corresponding hazard records.

The server notifies terminals in real time by using a notification subsystem. The server identifies target terminals such as smartphones, tablets, or head-mounted displays registered for specific work zones or roles. The server composes a notification message containing the guidance text, hazard summary, and an optional link to the relevant image frame. The server sends this message through a push notification service or a persistent communication channel. The server may generate shortened versions of the text for devices with limited display space, such as smart glasses, while preserving the core instruction.

The terminal receives the notification and displays the guidance information to the user. When the terminal is a handheld device, the terminal presents the guidance in an application that renders a list of active hazards with color coding and icons. When the terminal is a visual presentation device such as a head-mounted display, the terminal overlays the guidance text within the user's field of view and may highlight an approximate direction or region corresponding to the hazard, using sensor data from the device to align the overlay if available.

The user observes the displayed guidance and takes physical action in the work area, such as instructing a worker to wear protective gear or to move away from equipment. The user may enter response information into the terminal, for example indicating that a hazard has been addressed or that additional explanation is required. The user may also input a question such as:
“What exact steps should I follow to ensure compliance and prevent recurrence?”

The terminal sends this response or inquiry information back to the server together with identifiers of the relevant hazard events and guidance messages.

The server receives the user response and generates an additional input prompt sentence. The server includes in this additional prompt the previous hazard description, the original guidance, and the user's question. For example, the server may construct a prompt such as:
“You previously advised that the worker on scaffolding third floor east side must wear required head protection. The supervisor now asks: ‘What exact steps should I follow to ensure compliance and prevent recurrence?’ Provide a step-by-step procedure, including communication with workers and periodic checks, in no more than eight bullet points.”

The server sends this additional prompt to the generative AI model. The generative AI model generates updated guidance information that includes more detailed, structured steps. The server then notifies the terminal with this refined guidance, thereby implementing an interactive dialogue loop that adjusts the level of detail and tone in response to user input.

The server improves computer technology in several ways. First, by integrating a high-throughput object detection model on a GPU with an event structuring pipeline and a prompt generation module, the server reduces latency between video capture and advisory output compared to systems that perform these steps manually or in separate subsystems. The server uses batched inference and optimized data transfer to minimize processing time, allowing near-real-time detection and notification. Second, the server improves accuracy by combining learned detection capabilities with explicit geometric and temporal rules, which are difficult for humans to apply consistently in real time. The machine learning model detects subtle patterns such as posture and equipment orientation, and the rule logic formalizes domain knowledge about safety distances and restricted zones.

Third, the server enhances data management by maintaining a structured event store that correlates raw frames, detection outputs, hazard records, prompts, and generated guidance. This structured approach allows efficient querying and analysis, reduces redundancy, and provides a clear audit trail that can be used to refine models or rules. Fourth, the server reduces communication load by generating concise, context-aware messages instead of transmitting large volumes of raw video to user devices. The server performs computation-intensive analysis centrally and sends only the essential actionable information, thereby optimizing network usage.

The server also implements non-conventional processing rules that differ from simple human task automation. For example, the server assigns risk scores using a function that combines multiple factors such as detection confidence, object class, spatial relationship, and duration in a time window. The server uses these scores to determine which hazards to include in prompt sentences and in what order, prioritizing high-risk events. This selective inclusion reduces the cognitive load on the generative AI model and on the user, and improves the overall system performance by avoiding unnecessary processing for low-risk events.

In another embodiment, the server uses a different neural network architecture for object detection, such as a vision transformer or a hybrid convolution-transformer model, while still generating the same structured hazard information. In yet another embodiment, the server uses a different generative model architecture, such as a recurrent network augmented with attention mechanisms, provided that the model accepts prompt sentences and outputs natural language guidance. In further embodiments, the server deploys the generative AI model locally instead of through an external endpoint, thereby reducing network latency and enabling offline operation in constrained environments.

The server may also adjust parameters of the generative AI model based on system load or required level of detail, for example by changing a length constraint or sampling strategy. The server can thus trade off between response speed and richness of guidance, which constitutes a technical optimization beyond simple automation of human decision-making.

In another variation, the server aggregates hazard events across multiple cameras and time intervals when generating prompt sentences, enabling the generative AI model to consider broader situational context. The server may include comparative phrases such as “compared to the previous hour” or “relative to other zones” when requesting guidance, and the model can generate recommendations such as reallocation of monitoring resources. This multi-source integration is implemented by explicit data fusion logic in the server, rather than by human observation, and contributes to improved detection of systemic risks.

In all embodiments, the server, the terminals, and the user cooperate through the described pipeline of video acquisition, structured hazard analysis, prompt sentence generation, generative AI model inference, guidance notification, and interactive refinement. By coupling specific data structures, neural network architectures, and rule-based hazard classification with an adaptive dialogue mechanism, the system achieves technical effects including higher detection accuracy, reduced processing latency, improved consistency of advisory messages, and more efficient network utilization. These effects arise from the particular configuration and cooperation of the server modules and the terminals, and not merely from automating pre-existing human mental processes.

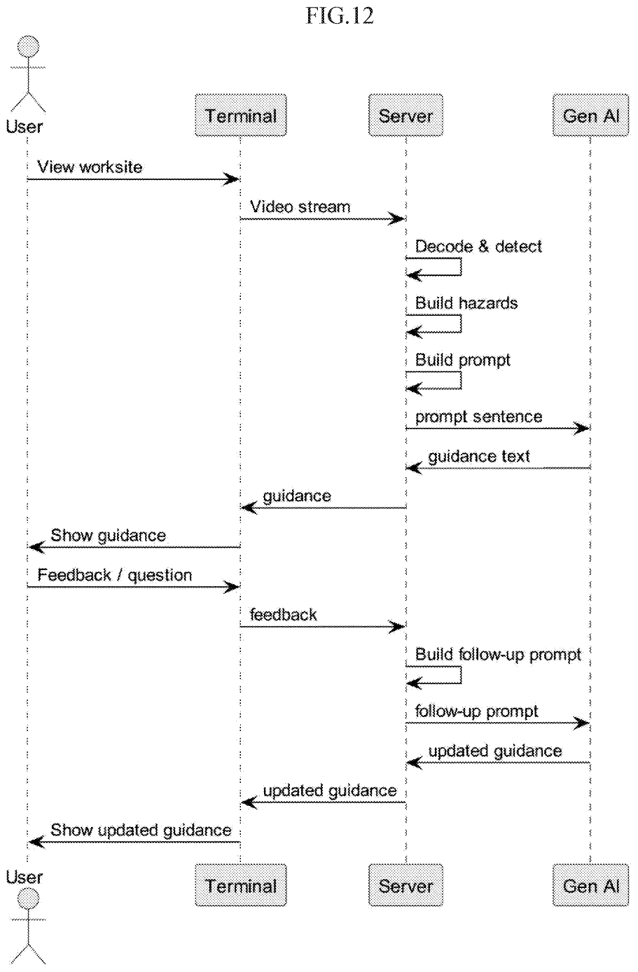

The following describes the processing flow using FIG. 12.

### Step 1:

The server receives encoded video streams from imaging devices installed in the work area.
The input is compressed video data including timestamps and camera identifiers, received via a network interface.
The server uses a communication module to accept packets, reassembles them into a continuous stream, and decodes session headers.
The server outputs a sequence of encoded video frames associated with camera IDs and time information and stores them temporarily in a buffer or storage device.

### Step 2:

The server decodes the encoded video frames into raw image data and preprocesses the images for analysis.
The input is the sequence of encoded video frames from Step 1.
The server uses a media processing library to perform video decoding, generating arrays of pixel values for each frame.
The server resizes each frame to a predetermined resolution, normalizes pixel values to a predefined numeric range, and converts the frames into tensor structures suitable for neural network processing.
The output is a batch of preprocessed image tensors, each linked to a camera ID and timestamp.

### Step 3:

The server performs object detection on the preprocessed image tensors using a trained machine learning model.
The input is the batch of preprocessed image tensors from Step 2.
The server loads a convolutional or transformer-based object detection model into memory, transfers the tensors to GPU memory, and executes forward inference.
The server computes, for each frame, bounding box coordinates, class labels (for example, worker, protective gear, vehicle, edge, restricted marker), and confidence scores by applying convolution operations, activation functions, and detection heads.
The output is a set of raw detection results for each frame, including object categories, positions, and confidence values.

### Step 4:

The server refines detection results and determines hazardous regions and hazardous actions.
The input is the set of raw detection results from Step 3.
The server applies a non-maximum suppression algorithm to remove overlapping bounding boxes with lower confidence and retains the most reliable detections.
The server maps bounding box coordinates to configured physical zones using camera calibration data and a zone configuration database.
The server applies rule logic to determine hazards, for example, checking whether a detected worker lacks a detected protective equipment object in a head region, whether a worker's bounding box overlaps a restricted area, or whether the distance between a worker and moving equipment is below a threshold.
The output is a list of hazard instances describing hazardous regions and hazardous actions with associated object references, zones, and timestamps.

### Step 5:

The server generates structured hazard information records based on the identified hazards.
The input is the list of hazard instances from Step 4.
The server constructs structured records that include fields such as hazard type, involved objects, spatial zone identifier, time, and computed risk score.
The server calculates the risk score using a function that combines object type, distance, duration, and detection confidence, producing a numeric or categorical risk level.
The server stores the structured hazard records in a database for later retrieval.
The output is a set of structured hazard information entries indexed by time and location.

### Step 6:

The server constructs a prompt sentence for a generative AI model using the structured hazard information.
The input is the set of structured hazard information entries from Step 5.
The server selects current or high-priority hazard entries and converts them into textual descriptions, such as “a worker without required head protection on the third-floor east-side platform” or “a powered machine operating within 0.5 meters of a pedestrian path.”
The server inserts these textual descriptions into a prompt template, for example:
“From the following hazard detection results, identify all dangerous regions and dangerous actions and generate specific corrective guidance for the on-site supervisor. Use clear, concise English suitable for immediate action. Detected hazards: [hazard list].”
The server concatenates the template and hazard descriptions into one coherent prompt sentence.
The output is a complete natural language prompt sentence ready for submission to the generative AI model.

### Step 7:

The server transmits the prompt sentence to the generative AI model and receives advisory output.
The input is the prompt sentence from Step 6.
The server packages the prompt sentence into a request format accepted by the generative AI model interface and sends it via a secure network connection.
The generative AI model processes the prompt internally and returns a natural language response.
The server receives the response, parses the returned data structure, and extracts the advisory text generated by the model.
The output is advice information in natural language, including recommended safety measures and work procedures related to the hazards.

### Step 8:

The server converts the advice information into guidance information and prepares notification messages.
The input is the advice information from Step 7 and the structured hazard information from Step 5.
The server associates the advice text with corresponding hazard identifiers and risk levels, then formats it as guidance information that may include a title, a main instruction body, severity indicators, and optional references to image frames.
The server optimizes message length and structure for different device types, generating concise versions for small displays and full versions for larger screens.
The output is a set of device-specific notification payloads containing guidance information, ready to be sent to terminals.

### Step 9:

The server sends guidance notifications to terminals in the work area.
The input is the set of notification payloads from Step 8.
The server selects target terminals based on user roles, subscribed zones, and hazard severity, and routes each payload to appropriate devices using push notification services or persistent communication channels.
The server transmits the payloads, including guidance text and optional media references, over the network.
The output is delivered notification messages stored in terminal queues or displayed by terminal applications.

### Step 10:

The terminal receives guidance information and presents it to the user.
The input is the notification message from Step 9.
The terminal's communication module accepts the message, and the terminal's application parses the payload to extract the guidance text, hazard summary, and any frame or zone references.
The terminal renders the guidance on a display, for example showing a warning banner, a list of actionable steps, and possibly a thumbnail image.
If the terminal is a head-mounted display, the terminal overlays the guidance text within the user's field of view.
The output is a visual or audio presentation of the guidance information to the user.

### Step 11:

The user reviews the guidance and optionally provides response or inquiry information.
The input is the displayed guidance from Step 10.
The user performs physical actions in the work area according to the instructions, such as stopping work, requiring protective equipment use, or clearing a hazardous region.
The user may enter feedback through the terminal, for example selecting an option such as “resolved,” “not applicable,” or “false alarm,” or typing or dictating a question like “What additional measures should I take in this area?”
The output is user-generated response information or inquiry information captured by the terminal.

### Step 12:

The terminal sends the user's response or inquiry information to the server.
The input is the response or inquiry information created in Step 11.
The terminal packages the user input with associated hazard identifiers, timestamps, and device identifiers and transmits this package to the server via the communication interface.
The terminal may confirm successful transmission to the user with a status indicator.
The output is a message at the server side containing user feedback linked to specific hazard events.

### Step 13:

The server generates an additional input prompt sentence incorporating user feedback and prior guidance.
The input is the user response or inquiry information from Step 12 and the related structured hazard information and previous guidance information from storage.
The server composes a new natural language prompt that includes a summary of the original hazard, the original advice, and the user's question or status update.
For example, the server constructs a prompt such as:
“You previously advised that the worker on the third-floor east-side platform must wear required head protection. The supervisor now asks: ‘What exact steps should I follow to ensure compliance and prevent recurrence?’ Provide a step-by-step procedure, including communication with workers and periodic checks, in no more than eight bullet points.”
The output is an additional input prompt sentence that reflects both system analysis and user interaction.

### Step 14:

The server sends the additional input prompt sentence to the generative AI model and updates the guidance.
The input is the additional input prompt sentence from Step 13.
The server transmits this prompt to the generative AI model through the same or a similar interface as in Step 7.
The generative AI model produces a refined natural language response with more detailed or adjusted guidance.
The server receives and extracts the updated guidance text and stores it associated with the corresponding hazard and dialogue context.
The output is updated guidance information that incorporates user feedback.

### Step 15:

The server notifies the terminal of the updated guidance and continues the interactive loop as needed.
The input is the updated guidance information from Step 14.
The server formats the updated guidance into a new notification payload and sends it to the relevant terminal in the same manner as in Step 9.
The terminal receives and displays the updated guidance to the user, enabling further clarification or confirmation.
The output is an ongoing interactive advisory process in which hazards, guidance, and user responses are iteratively refined through coordinated processing by the server, the terminals, and the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In industrial work environments such as construction sites, manufacturing facilities, and logistics centers, it is necessary to continuously monitor on-site conditions and provide workers with timely and context-appropriate safety guidance. Conventional computer-implemented safety systems typically rely on static rule sets, manually designed checklists, or simple threshold-based detection algorithms. These systems suffer from several technical drawbacks when implemented on general-purpose computer hardware.

First, conventional systems do not efficiently integrate high-volume image information acquired from imaging apparatuses with downstream generation of safety instructions. Raw images or video streams are often stored or processed in isolation, without an automated pipeline that converts machine-detected dangerous areas into structured, machine-readable data suitable for downstream processing. As a result, the processor must perform multiple ad hoc conversions and manual interventions, which lead to increased computational overhead, latency, and inconsistent data formats.

Second, conventional systems generally treat risk detection and instruction generation as separate and disjoint processes. A detection module may identify objects or events, but the output is not automatically transformed into an optimized natural language input for a generative AI model. Without a structured and adaptive prompt sentence construction mechanism, the generative AI model may receive incomplete, noisy, or redundant information, which degrades the quality, relevance, and consistency of the generated guidance. This causes inefficiencies in the use of computational resources and results in guidance that is not well aligned with the detected dangerous area or the state of workers.

Third, conventional systems often lack a feedback-driven adaptation mechanism. Even when a user or a terminal device provides information about how detected dangerous areas were actually addressed, that response information is rarely fed back into the processing pipeline in a structured way. Accordingly, the trained discrimination model used for detection and the prompt sentence configuration used for generative AI input remain static. This prevents the system from improving its analytical accuracy, reducing false positives or false negatives, or optimizing the expression format and output format of guidance over time based on real operational outcomes.

Fourth, typical implementations do not handle structured data composition and embedding into prompts in a unified manner. Information such as worker equipment state, spatial position of dangerous areas, and time-series patterns are often handled by separate modules or not handled at all. As a consequence, the processor is not effectively configured to construct prompts that exploit the full context available from structured data. This limits the ability of the system to obtain, in parallel, both evaluation results and tailored safety measures from a generative AI model.

Therefore, a technical problem to be solved by the present invention is to improve the functioning of a computer system that performs safety monitoring and guidance by (i) providing an integrated and automated processing pipeline from image acquisition to generation of guidance information, (ii) structurally coupling a trained discrimination model and a generative AI model via machine-constructed prompt sentences, and (iii) using response results from terminal devices to adapt models and prompt configurations over time, thereby improving computational efficiency, data consistency, and the technical quality of generated outputs.

The specific processing by the specific processing unit 290 of the data processing device 12 in Example 2 is realized by the following means.

The present invention provides a server comprising a processor configured to acquire image information from an imaging apparatus that captures a situation in a work environment and to record the image information in a storage resource; to analyze the recorded image information by executing a trained discrimination model using a computation resource so as to specify a dangerous area in the work environment and state information of a worker related to the dangerous area; to generate a prompt sentence by composing, as a natural language input sentence, safety measure content for the dangerous area based on the specified dangerous area and the state information, to input the prompt sentence into a generative artificial intelligence model, and to cause the generative artificial intelligence model to generate guidance information regarding the safety measure content; to transmit the guidance information to a terminal device and cause the terminal device to present the guidance information to a user; and to record, in the storage resource, information on a response result to the dangerous area received from the terminal device and to update at least one of the trained discrimination model and a configuration content of the prompt sentence in accordance with the response result. This enables an integrated computer-implemented safety support pipeline in which image-based detection of dangerous areas and worker states is technically coupled to adaptive prompt construction and generative guidance output, thereby improving the efficiency and reliability of risk analysis, reducing manual intervention and data inconsistency, and continuously enhancing model behavior and output formats based on real feedback from terminal devices.

The term “processor” refers to a hardware computation unit, such as a central processing unit or graphics processing unit, or a combination thereof, configured to execute instructions of a program to perform data acquisition, analysis, generation, storage, and communication operations as described in the present specification.

The term “imaging apparatus” refers to a hardware device configured to capture visual information representing a situation in a work environment, including but not limited to a camera, an image sensor, or a composite device having an image sensor and associated optics and communication circuitry.

The term “image information” refers to digital data representing an image or a sequence of images, including still images, video frames, or encoded video streams, that are acquired from the imaging apparatus and processed by the processor.

The term “work environment” refers to a physical area in which human work activities are performed, including but not limited to construction sites, manufacturing facilities, warehouses, and logistics centers, in which safety-related monitoring and guidance are required.

The term “storage resource” refers to a physical or logical data storage component, including but not limited to a semiconductor memory, a magnetic disk, an optical disk, or a database system, configured to store image information, structured data, model parameters, response results, and other information used by the processor.

The term “computation resource” refers to a hardware and software combination, including but not limited to processors, accelerators, memory subsystems, and associated drivers or libraries, which is used to execute numerical and logical operations required for model inference and data processing.

The term “trained discrimination model” refers to a learned computational model, such as a machine learning model or a statistical inference model, that has been trained on sample data to perform classification, detection, segmentation, or other discriminative tasks for specifying dangerous areas and worker states from image information.

The term “dangerous area” refers to a region in the work environment determined by the trained discrimination model or associated processing to have an elevated risk of accident, injury, or safety violation, based on analysis of image information and contextual data.

The term “state information” refers to data describing one or more characteristics, conditions, or behaviors of a worker, including but not limited to posture, position, motion, equipment usage, and other observable attributes derived from the image information or related analysis.

The term “worker” refers to a human person performing tasks or activities in the work environment, whose safety status and behavior are subject to monitoring and guidance by the system.

The term “safety measure content” refers to information representing one or more recommended actions, procedures, or controls intended to reduce risk or improve safety in relation to a dangerous area and associated worker state information.

The term “prompt sentence” refers to a natural language input sentence or group of sentences constructed by the processor so as to describe a situation, safety measure content, or request, and supplied as input to a generative artificial intelligence model for generation of corresponding output information.

The term “generative artificial intelligence model” refers to a learned computational model configured to produce new data, such as natural language text, in response to an input, including but not limited to a large language model that outputs guidance information based on a prompt sentence.

The term “guidance information” refers to output information generated by the generative artificial intelligence model that provides instructions, recommendations, explanations, or other safety-related content for addressing a dangerous area and associated worker state information.

The term “terminal device” refers to an information processing apparatus distinct from the server, including but not limited to a mobile device, a tablet, a personal computer, or a dedicated display unit, configured to communicate with the server, receive guidance information, and present such information to a user.

The term “user” refers to a human person who interacts with the terminal device and utilizes the guidance information, including but not limited to a supervisor, safety manager, or worker in the work environment.

The term “response result” refers to information indicating how a dangerous area was handled or addressed in the work environment, including but not limited to confirmation of implementation of safety measures, status changes, or feedback entered via the terminal device and supplied to the server.

The term “configuration content of the prompt sentence” refers to one or more elements defining how a prompt sentence is constructed, including but not limited to template structures, expression formats, inclusion or exclusion of specific data fields, and requested output styles, which can be updated based on response results.

The term “structured data” refers to data organized in a predefined schema or format, such as a record, table, or hierarchical object, including fields for worker equipment state information, position information of a dangerous area, and other attributes extracted from image information.

The term “equipment state information” refers to data describing the presence, absence, or condition of protective or work equipment associated with a worker, including but not limited to helmets, harnesses, protective clothing, and other safety-related items, as determined from image information or analysis results.

The term “position information” refers to data indicating a spatial location or region of a dangerous area or a worker within the work environment, expressed, for example, in coordinates, zones, or identifiers associated with a site map or reference frame.

The term “time-series analysis results” refers to data representing analytical outputs obtained over time, including but not limited to sequences of detection results, state transitions, or risk level changes for dangerous areas and workers, derived from multiple instances of image information.

The term “expression format of the prompt sentence” refers to stylistic and structural characteristics of a prompt sentence, including wording, level of detail, language register, and organization of information, which can be adjusted by the processor based on accumulated information.

The term “required output format” refers to a specification defining the desired structure, granularity, or categorization of guidance information generated by the generative artificial intelligence model, such as lists, step-by-step procedures, warnings, or educational narratives.

The term “procedure information” refers to guidance information that describes a sequence of operations or steps to be performed in order to mitigate or eliminate a risk in the dangerous area.

The term “warning information” refers to guidance information that alerts a user or worker to a specific risk, hazardous condition, or prohibited action in the dangerous area.

The term “educational information” refers to guidance information intended to improve knowledge or awareness of safety principles, correct behaviors, or best practices related to the work environment and identified risks.

In one embodiment, a server, a terminal, and a user cooperate to implement the claimed system in a concrete computer architecture. The server comprises at least one processor, a main memory, a non-volatile storage device, a network interface, and a connection to at least one imaging apparatus deployed in a work environment. The terminal comprises a processor, a display unit, an input interface, and a communication interface. The user operates in the physical work environment and interacts with the terminal.

The server executes a server-side program stored in the non-volatile storage device and loaded into the main memory. The program may be implemented using a general-purpose programming language such as C++, Java, or Python and operates on an operating system such as a Unix-like operating system. The server connects to one or more imaging apparatuses, such as network cameras or industrial vision sensors, using a wired or wireless communication protocol such as Ethernet, Wi-Fi, or an industrial fieldbus.

The server acquires image information from the imaging apparatus. The imaging apparatus captures visual information of the work environment as digital video streams or still images. The imaging apparatus may generate compressed video streams using a codec such as H.264, H.265, or Motion JPEG. The server receives the compressed stream through the network interface, decodes the stream with a multimedia framework such as a general-purpose video library, and converts each frame into an in-memory multidimensional array, for example a three-dimensional array representing height, width, and color channels. The server stores the frames in the non-volatile storage device, such as a solid-state drive, and associates each frame with metadata including a timestamp, a camera identifier, and optional calibration parameters. The server maintains this data as structured records in a database system or as files organized in a directory hierarchy, thereby enabling efficient indexed access.

The server analyzes the stored image information by executing a trained discrimination model on a computation resource that includes at least one graphics processing unit. The trained discrimination model may be implemented using a machine learning framework such as a tensor-based computation library. The server loads model parameters from the storage device into the main memory and then transfers the parameters and input image tensors to the graphics processing unit using a device driver and an accelerator library such as a parallel computation runtime.

In one embodiment, the trained discrimination model has a convolutional neural network architecture designed for object detection and region classification. The model may include multiple convolutional layers, batch normalization layers, non-linear activation functions, and pooling layers, followed by feature aggregation layers and output layers producing bounding boxes and class probabilities. The server configures the model to output, for each frame or batch of frames, a set of predicted regions, each region being represented by coordinates, a class label such as “worker,” “machinery,” “protective equipment,” or “hazardous zone,” and a confidence score.

The server preprocesses the input image information by resizing each frame to a predetermined resolution required by the model, normalizing pixel intensity values to a standard numeric range, and optionally performing color space conversion. The server constructs a four-dimensional tensor representing a batch of frames and transfers this tensor to the graphics processing unit memory. The graphics processing unit executes the sequence of convolution, matrix multiplication, and activation operations described by the network graph, using parallel arithmetic units and optimized kernels. This hardware-accelerated processing reduces computation time for large volumes of image information compared with purely CPU-based processing.

The server postprocesses the raw model outputs by applying non-maximum suppression and thresholding. The server discards predicted regions whose confidence scores fall below a predetermined threshold, and merges overlapping regions that represent the same physical object or area. The server then interprets combinations of detected objects and their spatial relationships as dangerous areas. For example, when a detected worker region intersects or is within a specified distance of a detected moving machinery region, and when no protective equipment such as a helmet or harness is detected in association with that worker region, the server classifies that spatial region as a dangerous area. The server may use a rule set or a learned decision layer to map combinations of labels and spatial relations into dangerous area categories such as “fall risk,” “collision risk,” or “insufficient protective equipment.”

The server generates state information for each worker present in the image information. The state information may include position relative to reference points in the work environment, posture features such as bending or reaching, and equipment state information indicating presence or absence of specific protective items. The server represents this information as structured data, such as records having fields for worker identifier, location, detected equipment types, and associated risk labels. The server may also maintain time-series records for each worker, linking analyses over multiple frames to identify patterns such as recurring safety violations.

The server generates, for each dangerous area and associated worker state information, a prompt sentence to be input to a generative AI model. The server uses a prompt template stored in the storage device, where the template contains placeholders for area identifiers, risk types, descriptions of detected conditions, and desired output format. The server populates the placeholders with the structured data describing the dangerous area and worker states. In one example, the server constructs a prompt sentence as follows:
“In area A near a lifting device in the work site, one worker has been detected without a safety helmet while standing close to moving equipment. Based on this situation, please propose detailed and practical safety measures that a supervisor can immediately implement and also measures that can improve safety in the short term.”

In another example, the server constructs a prompt sentence such as:
“In work zone B of a manufacturing facility, a worker is standing within 0.5 meters of an unguarded moving conveyor without appropriate protective equipment. Please provide step-by-step safety countermeasures to reduce entanglement and crush injury risks, including immediate actions and procedure improvements.”

The server may include structured attributes directly in the prompt sentence, such as risk severity level, frequency of occurrence, or time-of-day information, thereby guiding the generative AI model to produce context-specific guidance. The server constructs such prompt sentences programmatically from the structured data, ensuring a consistent and machine-optimized format that differs from ad hoc human-written instructions.

The server transmits the generated prompt sentence to a generative AI model executing on a remote computation platform or on the same server. The server uses an application programming interface to send the prompt sentence and receive a response. The generative AI model may be a large language model implemented as a multi-layer transformer network with self-attention mechanisms. The model uses token embeddings and positional encodings, multiple attention heads, feed-forward layers, and normalization layers to transform the input prompt sentence into an internal representation and to generate a sequence of output tokens representing guidance information.

In order to train the generative AI model, a dataset of prompt response pairs may be constructed, where each prompt sentence encodes a hazardous situation and each response encodes desired guidance. A supervised learning procedure may be used, where a loss function such as cross-entropy measures the difference between generated token probabilities and reference tokens. The model weights are updated by backpropagation and gradient-based optimization, such as stochastic gradient descent or a variant of adaptive moment estimation. Data augmentation methods such as paraphrasing, synonym substitution, and variation of scenario details may be applied to increase the diversity of training prompts. In deployment, the server may adjust decoding parameters such as temperature, top-k, or top-p sampling to control diversity and specificity of generated guidance.

The server receives the guidance information produced by the generative AI model as natural language text. The guidance information may include procedural steps, warnings, and educational content. For example, the response may include sentences such as:
“1. Immediately instruct the worker in area A to wear approved protective headgear before resuming any tasks near moving equipment.
2. Conduct a short safety briefing for all workers in the vicinity, emphasizing mandatory use of protective headgear and safe distances from moving machinery.
3. Place clear and durable signage at the entrance to area A specifying that protective headgear is required beyond this point.
4. Implement a daily checklist for supervisors to verify that all workers near lifting equipment are wearing proper protective equipment at the start of each shift.”

The server parses the guidance information and stores the text in association with the corresponding dangerous area and worker state record. This association is recorded in the storage resource as part of a guidance history, enabling later reference and analysis.

The server transmits the guidance information and associated dangerous area information to the terminal. The server may package the dangerous area identifier, a summary description, a representative image reference, and the text of the guidance information in a structured payload. The server sends the payload to the terminal using a network protocol such as Hypertext Transfer Protocol Secure over wireless or wired communication infrastructure. The server may optionally compress the data or selectively omit non-essential fields to reduce communication load, particularly in bandwidth-constrained environments.

The terminal receives the payload and stores it in a local memory or a lightweight database.

The terminal displays, on its display unit, the dangerous area summary, a visualization of the area such as an image with highlighted regions, and the guidance information. The terminal may present the guidance information grouped into procedure information, warning information, and educational information, based on tags or patterns provided by the server or inferred from the text. The terminal allows the user to scroll through the content, zoom into images, and access related past incidents.

The user views the displayed dangerous area and the guidance information and then acts in the physical work environment. The user may instruct a worker to wear specific protective equipment, place additional barriers, or modify the layout of equipment. The user may also provide feedback using the terminal, by selecting a control indicating that the suggested measures have been implemented, by entering comments, or by indicating that the dangerous area was a false positive. The terminal sends this response result back to the server.

The server records the response result in the storage resource and links it to the corresponding dangerous area, worker state information, and guidance information. The server uses this historical data to adapt the trained discrimination model and the prompt sentence configuration. In one embodiment, the server identifies patterns of repeated false positives or false negatives and selectively adjusts thresholds, modifies feature weighting, or retrains parts of the discrimination model with updated datasets, thereby improving detection accuracy. In another embodiment, the server analyzes which kinds of prompt sentences and expression formats lead to efficient resolution of dangerous areas, as indicated by quick response times or fewer residual incidents, and updates prompt templates accordingly. For example, if short, imperative-style prompts yield more concise and implementable guidance for certain types of risks, the server reconfigures future prompts for those risk types to follow that expression format.

The server maintains specific data structures to support these adaptations. For each dangerous area instance, the server stores a record containing the model detection output, the prompt sentence content and template version, the generated guidance information, the user response result, and a resolution status. The server periodically aggregates this data to compute performance metrics for the discrimination model and for different prompt configurations, such as average detection confidence, resolution time, and user-confirmed effectiveness. On the basis of these metrics, the server programmatically selects improved parameter values, template phrases, and output format requests, thereby continuously tuning the system behavior.

By structuring the processing pipeline in this manner, the server improves computational efficiency and data management compared with conventional systems that manually couple image analysis and instruction generation. The server uses batched tensor operations optimized for the graphics processing unit, reducing per-frame processing time. The server uses structured records linking detections, prompts, and responses, enabling constant-time lookup of related data and facilitating incremental retraining operations. The server reduces communication load by sending only essential, preprocessed summaries and text guidance to the terminal, instead of raw image streams or unfiltered detections.

The server implements a non-trivial transformation between low-level sensor data and high-level guidance information. The transformation is realized through specific neural network architectures and algorithmic steps that cannot be trivially performed by manual inspection. The discrimination model uses feature extraction and learned weights to infer dangerous areas from complex image patterns, and the generative AI model uses attention-based representations to synthesize guidance texts conditioned on structured context. The prompt sentence construction mechanism bridges these two models by converting structured detection outputs into a natural language form optimized for generative processing. This bridging step goes beyond merely replacing a human author with an automatic text generator; it creates a technical integration that shapes the internal representations in both models, resulting in improvements in accuracy, consistency, and responsiveness.

The terminal and the server thus cooperate to provide a technical improvement in computer-based safety monitoring and guidance. The described combination of specific data structures, neural network architectures, training methods, prompt sentence construction rules, and feedback-driven adaptation mechanisms produces technical effects such as reduced processing latency, lower error rates in dangerous area detection, more stable text output formats, and more efficient network usage. These effects arise from particular configurations of computer hardware and software and from specific algorithmic flows rather than from a mere automation of human decision-making.

In alternative embodiments, the server may employ different neural network architectures for the discrimination model, such as a recurrent neural network for time-series analysis, a graph neural network to model relations among workers and equipment, or a hybrid model combining convolutional and transformer layers for improved spatial-temporal reasoning. The server may also integrate other sensor modalities, such as depth sensors or inertial measurement units, and fuse their outputs with image information in a multi-modal representation. The generative AI model may be replaced with a smaller domain-specific language model deployed locally on the server when network access to an external platform is limited, and the prompt sentence configuration may be adapted to match the capabilities of that model.

In another variant, the terminal may locally generate secondary prompt sentences based on the initial guidance information, for example to request clarification or to translate the guidance into another language, while still relying on the same core mechanism of structured prompt sentence construction and generative output. In all such embodiments, the core technical concept remains that the server uses a trained discrimination model to convert sensor-originated image information into structured representations of dangerous areas and worker states, uses a programmatically constructed prompt sentence to interface with a generative AI model, and uses response results from the terminal to update both model parameters and prompt configurations over time, thereby improving the overall functioning of the computer-based safety support system.

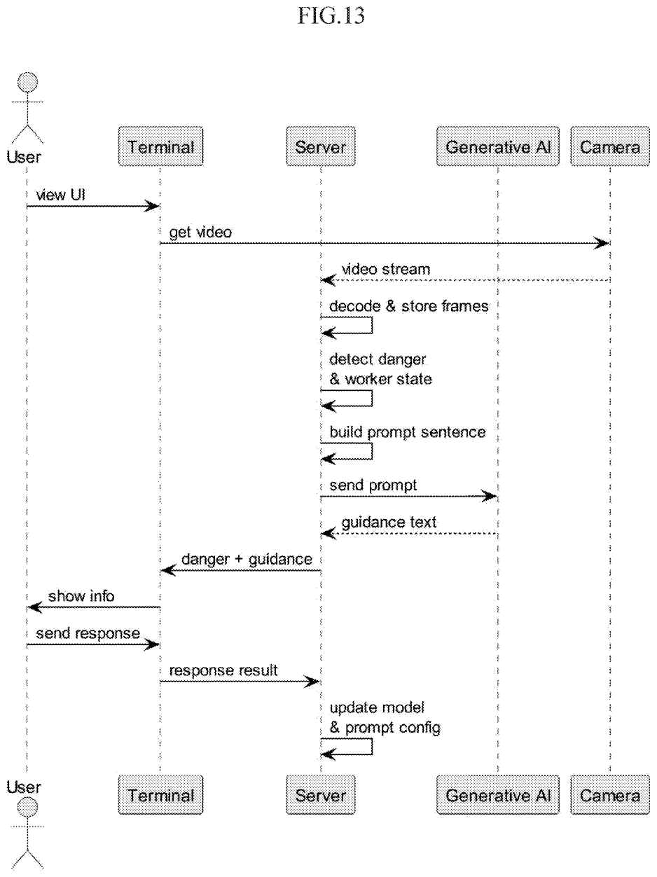

The following describes the processing flow using FIG. 13.

### Step 1:

The server acquires raw image data from the imaging apparatus.
The server receives, as input, a compressed video stream or still images generated by the imaging apparatus, together with metadata such as timestamps and camera identifiers. The server decodes the compressed stream using a multimedia library, converts each frame into an array of pixel values, and attaches metadata fields. The server outputs decoded image frames and associated metadata stored temporarily in main memory and/or a storage device.

### Step 2:

The server stores and indexes the image data.
The server takes, as input, the decoded image frames and metadata from Step 1. The server writes each frame to a non-volatile storage device and creates an index entry containing a frame identifier, timestamp, camera identifier, and file path or database key. The server outputs a persistent dataset of image records that can be retrieved by frame identifier and time range.

### Step 3:

The server preprocesses image data for model inference.
The server takes, as input, a set of stored image frames selected by frame identifiers or time intervals from Step 2. The server resizes each frame to a predetermined resolution, normalizes pixel intensity values to a fixed numeric range, and optionally converts color channels. The server groups multiple preprocessed frames into a batch tensor and transfers this tensor to a computation resource such as a graphics processing unit. The server outputs a batched tensor of image data with standardized dimensions ready for input to the trained discrimination model.

### Step 4:

The server executes the trained discrimination model to detect objects and candidate hazardous patterns.
The server receives, as input, the batched tensor of preprocessed frames from Step 3. The server invokes a neural network consisting of convolutional layers, non-linear activation layers, and output layers that compute bounding boxes, class probabilities, and feature maps.
The server performs numerical operations including convolutions, matrix multiplications, and pooling, using the graphics processing unit to parallelize calculations. The server outputs, for each frame, a list of candidate detections containing region coordinates, class labels such as worker, machinery, or protective equipment, and confidence scores.

### Step 5:

The server postprocesses detections and specifies dangerous areas.
The server takes, as input, the list of candidate detections per frame from Step 4. The server applies non-maximum suppression to remove overlapping detections of the same object and discards detections whose confidence scores are below a predetermined threshold. The server evaluates spatial relations among detections, such as distances between workers and machinery or absence of protective equipment within a worker region, using geometric calculations on bounding box coordinates. The server aggregates detections across successive frames to identify persistent risk regions and assigns dangerous area identifiers and risk types.
The server outputs structured dangerous area records containing area identifiers, risk categories, spatial coordinates or zone identifiers, and references to representative image frames.

### Step 6:

The server derives worker state information associated with each dangerous area.
The server receives, as input, the dangerous area records and detection outputs from Step 5.
The server associates each worker detection with a dangerous area based on spatial overlap or proximity thresholds. The server computes worker state attributes, including equipment state information (presence or absence of specific detected equipment classes), position relative to the dangerous area, and optionally posture features estimated from body keypoints if available. The server encapsulates these attributes into structured worker state records. The server outputs, for each dangerous area, a set of worker state records linked to that dangerous area.

### Step 7:

The server constructs structured data for prompt generation.
The server takes, as input, the dangerous area records and worker state records from Step 6.
The server composes structured data objects containing fields such as area identifier, risk type, severity level, worker equipment state, and representative timestamp. The server validates the completeness of these objects and may compute additional derived fields, such as a textual risk summary or an aggregated risk score. The server outputs structured data objects that serve as intermediate representations for constructing a prompt sentence.

### Step 8:

The server generates a prompt sentence for the generative AI model.
The server receives, as input, the structured data objects from Step 7. The server selects a prompt template based on the risk type and severity and fills placeholder tokens with concrete values, such as area identifier, description of detected conditions, and the desired form of output. The server performs string substitution operations and may reorder clauses according to the selected expression format. The server outputs a prompt sentence in natural language. For example, the server may output:
“In area A near a lifting device in the work site, one worker has been detected without a safety helmet while standing close to moving equipment. Based on this situation, please propose detailed and practical safety measures that a supervisor can immediately implement and also measures that can improve safety in the short term.”

### Step 9:

The server sends the prompt sentence to the generative AI model and receives guidance information.
The server takes, as input, the prompt sentence generated in Step 8. The server encapsulates the prompt sentence in a request message and transmits the request through a network interface to a generative AI model endpoint. The server waits for a response and then parses the received message to extract generated natural language guidance text. The server performs minimal postprocessing, such as trimming whitespace or separating numbered steps. The server outputs guidance information text associated with the corresponding dangerous area.

### Step 10:

The server links guidance information to dangerous area records and prepares a payload for the terminal.
The server receives, as input, the guidance information from Step 9 and the dangerous area records from Step 5 and Step 6. The server combines these data into a payload that includes the dangerous area identifier, summary description, worker state summary, representative image reference, and the guidance text. The server may compress or serialize the payload as a structured message suitable for network transmission. The server outputs a composed payload ready to be sent to the terminal.

### Step 11:

The server transmits the payload to the terminal.
The server takes, as input, the composed payload from Step 10. The server sends the payload to the terminal over a communication channel such as a secure network connection. The server may assign a unique message identifier and log the transmission status in the storage device. The server outputs a delivered network message that the terminal can receive and decode.

### Step 12:

The terminal receives and parses the payload.
The terminal receives, as input, the network message transmitted in Step 11. The terminal decodes the message format and extracts individual fields, including the dangerous area identifier, description, image reference, and guidance information. The terminal stores the extracted data in local memory structures for subsequent display and interaction. The terminal outputs a set of local data objects representing the dangerous area and its associated guidance.

### Step 13:

The terminal renders dangerous area information and guidance for the user.
The terminal takes, as input, the local data objects from Step 12. The terminal retrieves the representative image using the image reference, applies a visual overlay such as a bounding box or shaded region to highlight the dangerous area, and arranges the guidance text on the display. The terminal formats the guidance into sections such as procedure information, warning information, and educational information, using simple classification logic or tags from the server. The terminal outputs a graphical user interface presenting the dangerous area visualization and readable guidance text to the user.

### Step 14:

The user reviews the guidance and performs on-site actions.
The user receives, as input, the displayed dangerous area visualization and guidance information from Step 13. The user interprets the described risk and instructions and then moves within the physical work environment to take action, such as instructing a worker to wear required protective equipment or adjusting the layout around the dangerous area. The user may decide which recommended steps to carry out and in what order. The user outputs physical actions in the real-world environment and optionally prepares feedback to send via the terminal.

### Step 15:

The terminal collects a response result from the user.
The terminal receives, as input, user interactions such as button selections, text comments, or status indicators entered after reviewing the guidance. The terminal associates these interactions with the corresponding dangerous area identifier and guidance instance and encodes a response result that may include fields such as “implemented,” “partially implemented,” or “false positive,” along with timestamps and optional notes. The terminal outputs an encoded response result message addressed to the server.

### Step 16:

The terminal transmits the response result to the server.
The terminal takes, as input, the encoded response result from Step 15. The terminal sends the response result to the server using a network protocol, possibly batching multiple response results to reduce transmission overhead. The terminal may display a confirmation to the user once the message is successfully delivered. The terminal outputs a network message containing the response result to the server.

### Step 17:

The server stores response results and updates internal records.
The server receives, as input, the response result message from Step 16. The server parses the message, associates the response result with the corresponding dangerous area record, and writes an updated record to the storage device, including resolution status and any user comments. The server may compute derived statistics such as resolution time or implementation rate. The server outputs updated database entries linking dangerous areas, guidance information, and response results.

### Step 18:

The server analyzes accumulated response results to adjust model behavior and prompt configuration.
The server takes, as input, a collection of stored response results and associated detection and guidance records from Step 17. The server executes statistical analysis and machine learning procedures, such as computing false positive rates per risk type and correlating prompt expression patterns with successful resolutions. The server updates parameters of the trained discrimination model, for example by adjusting detection thresholds or selecting new training samples for fine-tuning, and modifies prompt templates or required output formats based on observed effectiveness. The server outputs revised model parameters and updated prompt configuration data that will be applied in subsequent executions of the earlier steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional safety management systems in industrial work spaces generally rely on static rule engines or fixed computer-vision pipelines that detect predefined objects or zones and then issue hard-coded warnings. Such systems typically process image data in isolation, without integrating multimodal information such as audio and emotional state of workers, and without adapting the content, tone, or level of detail of guidance to the current context. As a result, these systems often generate either overly generic or excessively verbose messages that workers ignore, or they fail to prioritize situations in which a combination of environmental risk and worker stress or fatigue creates a heightened danger.

In addition, existing computer-implemented safety systems usually separate low-level perception (for example, object detection, posture estimation) from higher-level instruction generation. The mapping from detected hazards to natural-language guidance is often implemented as a fixed set of templates or rules. This architecture limits scalability and robustness: as new types of work environments, equipment, or procedures are introduced, the rule base must be manually extended. Furthermore, these systems do not exploit advances in generative information processing models that can transform structured situational data into high-quality, context-sensitive natural-language guidance. Consequently, the overall computer system cannot flexibly adapt to diverse hazardous conditions or dynamically adjust guidance to the worker's emotional state.

Another problem is that prior systems do not treat the construction of prompts for a generative information processing model as a first-class computational process. In many cases, if generative models are used at all, they are supplied with ad-hoc, manually written prompts that do not systematically encode structured risk evaluation information or emotion analysis information. This leads to inconsistent output and reduces reliability, since the model is not constrained or guided by machine-generated situation descriptors tied to concrete sensor data. In particular, there is no integrated mechanism for the processor to (i) fuse computer-vision analysis and emotion analysis into risk evaluation information, (ii) automatically convert that information into a prompt sentence whose tone and level of detail are programmatically controlled, and (iii) feed back user responses to refine subsequent risk evaluation and prompt generation logic.

Accordingly, there is a need for an improved computer-implemented technique that, given multimodal sensor inputs from a work space, can automatically perform image analysis and emotion analysis, compute risk evaluation information, and then transform that information into structured prompt sentences for a generative information processing model. There is also a need for the computer system to control, via those prompt sentences, the manner in which the generative model produces safety guidance, including adjustment of tone, detail, and procedural decomposition in accordance with the detected emotional state of the worker. Moreover, there is a need for a feedback loop in which worker responses are captured and used by the processor to update both risk evaluation and prompt-generation behavior, thereby improving the technical performance and adaptability of the safety guidance system over time.

The specific processing by the specific processing unit 290 of the data processing device 12 in Application Example 2 is realized by the following means.

The present invention provides a server comprising a processor configured to acquire image information and sound information of a work space from an image acquisition device and a sound acquisition device, to perform image analysis processing including object detection processing and posture estimation processing on the image information to generate analysis information identifying a worker, a presence or absence of protective equipment, and a danger zone in the work space, to analyze facial information and voice information based on the image information and the sound information to generate emotion analysis information estimating an emotional state of the worker, to calculate risk evaluation information by fusing the analysis information and the emotion analysis information so as to compute a risk index and classify the danger zone into risk categories, to convert the risk evaluation information into structured situation description data and automatically generate, from the situation description data, a prompt sentence in a natural language in which an expression style and a level of detail are programmatically adjusted in accordance with the emotional state, to input the prompt sentence into a generative information processing model and obtain from the generative information processing model safety guidance information including safety countermeasure content and work procedures with a tone and explanatory steps adapted to the emotional state, to transmit the safety guidance information to a portable information terminal or a display device for visual presentation or audio output to the worker, and to acquire response information or feedback information from the worker and update the risk evaluation information and generation conditions of the prompt sentence based on the response information or the feedback information. This enables the computer system to implement an integrated, feedback-driven pipeline in which multimodal sensor data are algorithmically transformed into structured risk descriptors and emotion-aware prompt sentences, thereby allowing the generative information processing model to produce more context-appropriate and effective safety guidance while improving the adaptability and technical performance of the underlying safety management computation over time.

The term “work space” refers to a physical environment in which a worker performs tasks, including but not limited to industrial sites, construction sites, factories, warehouses, and similar operational areas.

The term “image acquisition device” refers to an electronic apparatus configured to capture visual information of the work space, such as a camera, an imaging sensor, or a similar device capable of generating digital image information or video information.

The term “sound acquisition device” refers to an electronic apparatus configured to capture audio information from the work space, such as a microphone, an array of microphones, or a similar device capable of generating digital sound information.

The term “image information” refers to digital data representing visual content of the work space, including still images, video frames, or sequences of frames captured by the image acquisition device.

The term “sound information” refers to digital data representing acoustic content of the work space, including audio signals, segments of voice, or ambient noise captured by the sound acquisition device.

The term “worker” refers to a human operator or person present in the work space who performs tasks, operates equipment, or moves within the monitored environment.

The term “protective equipment” refers to any personal protective item intended to enhance the safety of the worker, including but not limited to helmets, safety belts, safety harnesses, goggles, gloves, protective footwear, and high-visibility clothing.

The term “danger zone” refers to a region or situation within the work space in which the risk of accident, injury, or hazardous exposure for the worker is determined to be higher than a predetermined threshold.

The term “image analysis processing” refers to computational processing performed on the image information to extract structured information, including but not limited to object detection, region segmentation, tracking, and posture estimation.

The term “object detection processing” refers to a type of image analysis processing that identifies and localizes objects of interest, such as workers, tools, machinery, or protective equipment, by outputting positions, categories, or confidence scores for those objects.

The term “posture estimation processing” refers to a type of image analysis processing that estimates a physical pose or body configuration of the worker, including orientations and positions of body parts, to determine actions or working postures.

The term “analysis information” refers to structured data generated from the image analysis processing that describes detected entities, their attributes, and spatial relations in the work space, including identification of workers, presence or absence of protective equipment, and candidate danger zones.

The term “facial information” refers to image-based data representing a face region of the worker, including geometry, expression patterns, and visual features used for emotion estimation.

The term “voice information” refers to sound-based data representing the worker's speech or vocalization, including waveform characteristics, prosody features, and optionally transcribed text derived from speech recognition.

The term “emotion analysis information” refers to data indicating an estimated emotional state of the worker, such as calmness, stress, anxiety, fatigue, or similar conditions, obtained by analyzing the facial information and the voice information.

The term “emotional state” refers to a psychological condition of the worker, represented by one or more categories or continuous values, which may include states such as calm, anxious, stressed, fatigued, or similar affective conditions.

The term “risk index” refers to a numerical or categorical indicator computed for a worker or a region in the work space, representing an estimated level of safety risk based on the analysis information and the emotion analysis information.

The term “risk categories” refers to discrete classes for grouping danger zones or situations according to the risk index, such as low risk, medium risk, high risk, or critical risk.

The term “risk evaluation information” refers to structured data that aggregates the risk index and the risk categories for one or more workers or danger zones, and that represents an overall evaluation of safety risk in the work space.

The term “situation description data” refers to structured data derived from the risk evaluation information, comprising elements such as worker identifiers, hazard types, protective equipment status, danger zone attributes, and emotional state attributes, suitable for conversion into natural-language descriptions.

The term “prompt sentence” refers to a natural-language text generated by the processor that encodes the situation description data and includes instructions or contextual information used as input to a generative information processing model.

The term “expression style” refers to stylistic attributes of the prompt sentence or guidance text, such as tone, politeness level, directness, formality, and use of technical or non-technical wording.

The term “level of detail” refers to the extent and granularity of explanatory content included in a prompt sentence or guidance text, including the number of steps, amount of descriptive information, and specificity of instructions.

The term “generative information processing model” refers to a computational model that generates output data, such as natural-language text, based on input data including the prompt sentence, and that employs statistical, machine learning, or neural-network techniques to produce context-dependent responses.

The term “safety guidance information” refers to output data generated with the aid of the generative information processing model, including safety countermeasure content, recommended work procedures, warnings, and explanatory text adapted to the detected situation and emotional state.

The term “portable information terminal” refers to a mobile electronic device capable of wireless communication and user interaction, such as a handheld device, a wearable device, or a mobile computing device that can present or output the safety guidance information.

The term “display device” refers to an apparatus having a visual output component, such as a monitor, panel, or head-mounted display, that is configured to present the safety guidance information to the worker.

The term “response information” refers to data indicating an acknowledgment, confirmation, completion report, or request for assistance provided by the worker in reaction to the safety guidance information.

The term “feedback information” refers to additional data supplied by the worker or by another system component that describes outcomes, user understanding, preferences, or corrections related to the safety guidance information or detected risk, and that is used to refine subsequent processing.

The term “generation conditions of the prompt sentence” refers to parameters and rules used by the processor when generating the prompt sentence, including mapping rules from situation description data, tone control parameters, detail-level settings, and any adaptation logic based on past response information or feedback information.

In one embodiment, a server implements the claimed system by executing a set of software modules on a hardware platform that includes at least one central processing unit (CPU), a graphics processing unit (GPU), a main memory, a nonvolatile storage device, and a network interface. The server runs an operating system such as a general-purpose server operating system, and executes application software written, for example, in a programming language such as Python or C++. The server communicates with an image acquisition device, a sound acquisition device, and at least one terminal via a wired or wireless communication network using standard protocols.

Server uses the image acquisition device, implemented for example as a digital network camera with a CMOS image sensor, to capture image information of a work space. Server configures the camera to output compressed video streams using a codec such as H.264 over a streaming protocol such as RTSP. Server receives the video stream via the network interface and decodes it using a multimedia library such as a general-purpose decoding library, and stores decoded frames as image information in a frame buffer in main memory. Each frame is associated with metadata including a timestamp, a camera identifier, and a camera position.

Server uses the sound acquisition device, implemented for example as a network-connected microphone array, to capture sound information of the work space. Server receives pulse-code modulated (PCM) audio data in fixed-length segments (for example, 5-second windows) over a network transport protocol. Server stores the sound information as sequences of audio samples with metadata including timestamp and device identifier, aligned in time with the image information from the camera.

Server performs image analysis processing on the image information using a computer-vision pipeline implemented in software. Server first resizes each frame to a predetermined resolution and normalizes pixel values. Server then applies object detection processing using a convolutional neural network (CNN) detection model. In one embodiment, the detection model has a backbone network formed by stacked convolutional layers, batch normalization layers, and nonlinear activation functions such as rectified linear units, followed by detection heads that output bounding boxes, class probabilities, and confidence scores. The model is trained in advance using supervised learning on labeled image datasets containing examples of workers, protective equipment, and machinery.

Server detects instances of workers, protective equipment such as helmets and safety belts, and environment objects such as forklifts, ladders, and scaffolding. Server represents each detection as an element in a structured data record, for example a list of tuples including class identifier, bounding box coordinates, and confidence value. Server stores these data records in an in-memory data structure such as a dictionary or table keyed by frame identifier.

Server further performs posture estimation processing on regions of the image associated with workers. In one embodiment, server uses a neural network for human pose estimation that outputs coordinates of keypoints such as head, shoulders, elbows, hips, knees, and ankles. Server reconstructs a skeletal representation for each worker and classifies working posture, such as upright, bending, climbing, or leaning over an edge, using a rule-based classifier or a small neural network classifier applied to relative positions of keypoints. The resulting posture labels and confidence values are integrated into the analysis information.

Server thereby generates analysis information that describes, for each frame or for a set of consecutive frames, which workers are present, which protective equipment is detected on each worker, where potential hazards such as moving machinery or elevated positions are located, and how workers are positioned relative to such hazards. Server aggregates analysis information over time by associating detections corresponding to the same worker using a tracking algorithm such as Kalman filtering combined with feature-based association, and generates higher-level events such as “worker A is walking near a moving forklift without a helmet for more than 10 seconds.”

Server analyzes facial information and voice information to generate emotion analysis information estimating an emotional state of each worker. For facial information, server uses the output of the object detection processing or a face-detection module to locate face regions in the image information. Server crops and resizes each face region to a standard size, normalizes pixel values, and inputs the cropped image into an emotion classification neural network. This neural network is trained using supervised learning on facial expression datasets to output probability distributions over emotion categories such as neutral, happy, sad, angry, afraid, stressed, or fatigued. Server computes a primary emotional state by selecting the category with the highest probability, and stores both the category and the probability vector as part of the emotion analysis information.

For voice information, server segments the audio stream into short windows synchronized with the image frames. Server extracts acoustic features such as Mel-frequency cepstral coefficients, pitch contours, energy statistics, and speaking rate. Server also applies automatic speech-recognition processing to obtain transcribed text when speech is present. Server inputs the acoustic features into a recurrent neural network or transformer-based model trained to predict emotion labels from speech. Server may further analyze linguistic content of the transcribed text to detect keywords indicative of stress or confusion. Server combines the facial-based emotion output and the voice-based emotion output using a fusion algorithm, for example a weighted average of probability vectors, or a small neural network that takes both as input and produces a final emotional state estimate. Server records the emotional state for each worker with an associated timestamp and confidence.

Server calculates risk evaluation information by fusing the analysis information and the emotion analysis information. Server computes, for each worker and for each spatial region identified as a potential hazard, a risk index that is a function of at least the following factors: distance between the worker and the hazard, type of hazard (for example, collision risk from a vehicle, fall risk from height, entanglement risk from rotating machinery), presence or absence of relevant protective equipment, current working posture, and emotional state. In one embodiment, server uses a parametric function such as a weighted linear combination of normalized feature values, where weights are determined by prior configuration or by training on historical incident data. In another embodiment, server uses a feed-forward neural network that inputs a feature vector representing spatial relations and emotional features and outputs a risk score between 0 and 1.

Server maps each risk index into one of multiple risk categories such as low, medium, high, or critical based on predetermined thresholds. Server constructs risk evaluation information as structured situation description data that includes, for each high-risk or critical situation, identifiers of the worker, type of hazard, location or region identifier, protective equipment status, posture information, emotional state, risk index, and risk category. Server stores this situation description data in a machine-readable structure, for example in a relational database table or in a document-oriented datastore, and updates it as new frames and audio segments are processed.

Server converts the risk evaluation information into one or more prompt sentences in a natural language. Server uses a prompt-generation module that applies a deterministic mapping from fields in the situation description data to segments of natural-language text. In one embodiment, server maintains a set of template strings with placeholders for hazard type, equipment status, emotional state, and instructions on tone and level of detail. Server selects a template based on risk category and emotional state, and substitutes concrete values from the situation description data into the placeholders.

Server adjusts expression style and level of detail by encoding explicit instructions for the generative AI model inside the prompt sentence. For example, if the emotional state is calm, server may include an instruction such as “Provide concise and direct safety advice.” If the emotional state indicates anxiety, server may include an instruction such as “Politely and clearly explain, step by step, what safety measures the worker should take, and use a reassuring tone.” Thus, server programmatically controls the behavior of the generative AI model by modifying the content of the prompt sentence in response to computed risk evaluation information.

Concrete examples of prompt sentences generated by server include the following:
“Danger detected: A construction worker is walking inside a danger zone near moving heavy machinery without wearing a safety helmet. The worker appears calm. Provide concise and direct safety advice that tells the worker what to do immediately.”
“Situation: A worker is performing high-altitude work on scaffolding and is not wearing a safety belt. The emotion analysis indicates that the worker feels anxious. Politely and clearly explain, step by step, what safety measures the worker should take, and use a reassuring tone.”
“Using the summarized data from multiple cameras and sensors described below, identify all potential safety hazards and recommend specific countermeasures. Consider workers' emotional states (for example, fatigue, stress, anxiety) when prioritizing actions.”

Server inputs each prompt sentence into a generative information processing model, implemented for example as a large-scale neural-network-based language model executed on a dedicated inference service. Server transmits the prompt sentence as part of a request message over a secure protocol, and receives as a response a generated guidance text. The generative model internally uses a transformer architecture with multiple attention layers, feed-forward layers, and learned token embeddings, trained on large corpora of text to predict subsequent tokens conditioned on preceding tokens. In this embodiment, no model training is performed on the server; instead, server configures the model inference by supplying prompt sentences and parameters such as generation temperature or maximum output length.

Server parses the generated guidance text and may perform additional post-processing, such as removing unsupported suggestions, enforcing site-specific terminology, or splitting long paragraphs into bullet-like segments. Server constructs safety guidance information that includes, for each situation, at least one sentence of safety countermeasure content and, in many cases, a sequence of steps describing a work procedure. Because the prompt sentence encodes the emotional state and instructions about tone and level of detail, the generative information processing model produces output whose style is adapted to the worker's current condition.

Server transmits the safety guidance information to at least one terminal. The terminal is implemented for example as a handheld device, a wearable device, or an on-site display apparatus. Terminal runs a client application that maintains a persistent communication channel with server and receives safety guidance information as structured messages.

Terminal displays textual guidance on a screen using visual cues that depend on risk category, such as red highlighting for critical alerts and yellow highlighting for medium alerts. Terminal may also convert the textual guidance to synthesized speech using a text-to-speech engine on the device and output audio through a speaker or headset. In this way, the guidance is presented to the worker in real time and in a modality suitable for the work environment.

User interacts with the terminal to provide response information or feedback information. User may tap an “Acknowledged” button to indicate that a warning has been seen, may tap a “Completed” button to indicate that a recommended action has been carried out, or may select a “Need help” option to request additional explanation. User may also input free-form comments through speech or a text field, such as “I have put on the safety belt now” or “The area is already clear.” Terminal encodes these inputs as structured response information and transmits them back to server.

Server receives the response information and associates it with the corresponding situation description data and safety guidance information stored in the database. Server updates an internal state that indicates whether a particular risk has been resolved or remains active. Server also stores the response information and feedback information as training data or adaptation data for subsequent processing. In one embodiment, server uses this accumulated feedback to adjust weights in the risk index computation or to modify parameters used in prompt-sentence generation, such as increasing the default level of detail if workers frequently request more explanation for a particular class of hazards.

This architecture improves computer technology in several ways. First, by representing risk evaluation information as structured situation description data and using algorithmically generated prompt sentences that encode both hazard information and emotion-dependent control instructions, server enables the generative information processing model to produce consistent and context-appropriate output, reducing the need for large, manually crafted rule bases. Second, because server fuses multimodal features (vision, audio, and emotion) and uses trained neural networks for risk scoring instead of simple threshold-based rules, server can prioritize high-risk situations more accurately, thereby reducing false positives and enabling computational resources to be focused on truly critical events. Third, the feedback loop in which worker responses are stored and used to update risk evaluation and prompt-generation conditions allows the system to adapt over time, improving precision and reducing communication load by avoiding redundant or ineffective messages.

From a computational perspective, server reduces processing latency by partitioning the processing into specialized modules (image analysis, emotion analysis, risk evaluation, prompt generation, and model invocation) that operate on compact intermediate data structures instead of raw sensor streams whenever possible. For example, server transmits only situation description data and prompt sentences to the generative information processing model rather than entire image or audio streams, thereby lowering communication bandwidth requirements and enabling faster inference. Similarly, terminal presents pre-formatted guidance rather than performing heavy analysis locally, simplifying terminal hardware requirements.

In a variation of this embodiment, server may execute the generative information processing model locally on the GPU instead of calling a remote service. In that case, server stores the model parameters in nonvolatile storage and loads them into GPU memory at startup. Server then performs tokenization of prompt sentences, executes the transformer network on the GPU, and detokenizes the generated tokens back into natural-language text. The same overall processing flow of situation description to prompt sentence to safety guidance information applies, and the local execution can reduce inference latency in environments with limited network connectivity.

In another variation, server may incorporate additional sensors such as depth cameras, inertial measurement units on workers, or environmental sensors, and extend the analysis information and emotion analysis information to include features derived from these sensors. The risk evaluation function is then extended to incorporate these additional features. These variations remain within the scope of the system because the core operations of generating structured situation description data, generating a prompt sentence that encodes that data together with emotion-dependent control instructions, and using a generative AI model to produce adapted safety guidance remain unchanged.

In still another embodiment, terminal may locally generate secondary prompt sentences when user explicitly requests clarification. For example, when user selects “Need help,” terminal can create an additional prompt sentence such as “Explain in more detail why this situation is dangerous and how to avoid the risk, in simple language,” and send it to the generative information processing model via server. This allows on-demand expansion of guidance while still keeping the overall control and data fusion at server.

By implementing these specific data structures, neural-network architectures, fusion algorithms, and feedback-driven prompt-generation rules, the system provides more than a mere automation of human safety instruction. Server executes a non-conventional sequence of computational steps that leverages multimodal sensor fusion and dynamic prompt control to improve technical characteristics of the computer system itself, including improved risk detection accuracy, reduced false alarms, reduced bandwidth for remote model invocation, and better utilization of processing resources through prioritization of high-risk situations.

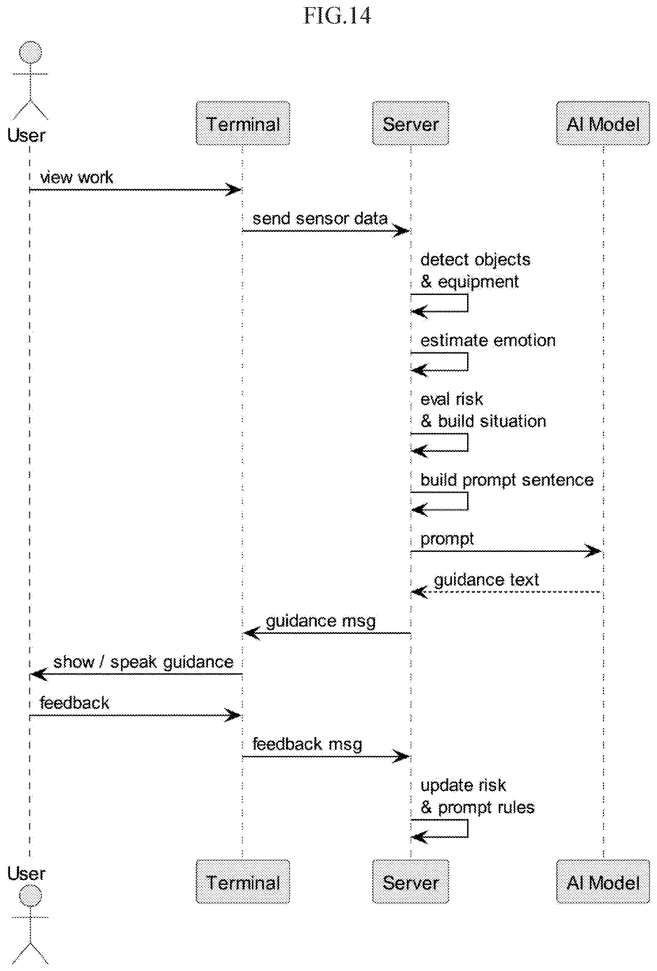

The following describes the processing flow using FIG. 14.

### Step 1:

Server acquires raw sensor data from the work space.
Server uses an image acquisition device to capture video streams and a sound acquisition device to capture audio streams. The input is compressed video (for example, H.264 over RTSP) and audio (for example, PCM over RTP) including timestamps and device identifiers. Server decodes the streams into individual image frames and audio segments using a multimedia library and stores them in memory as arrays of pixel values and audio samples. Server attaches metadata such as camera ID, microphone ID, and timestamps to each frame and audio segment. The output is a time-aligned sequence of image frames and audio segments with associated metadata.

### Step 2:

Server performs pre-processing on the image frames.
Server receives decoded image frames as input. Server resizes each frame to a fixed resolution (for example, 640×360 pixels), converts color format to a standardized space (for example, RGB), and normalizes pixel intensities to a predefined range. Server may also apply noise reduction or contrast enhancement using image-processing filters. These operations are executed using a computer-vision library. The data processing converts large, variable-size frames into compact, model-ready tensors. The output is a sequence of pre-processed image tensors indexed by frame ID and timestamp.

### Step 3:

Server executes object detection processing.
Server takes the pre-processed image tensors as input. Server feeds each tensor into an object detection neural network (for example, a convolutional network with a detection head). Inside the network, server applies convolution, pooling, and non-linear activation operations to extract feature maps, then applies detection heads to predict bounding boxes, class labels, and confidence scores. Server filters detections using a confidence threshold and non-maximum suppression. The data processing transforms raw pixels into structured detection records. The output is, for each frame, a list of detections, each including an object class (for example, worker, helmet, safety belt, vehicle), bounding box coordinates, and a confidence value.

### Step 4:

Server performs posture estimation for detected workers.
Server uses the detections of workers from Step 3 as input. For each worker detection, server crops the corresponding image region and resizes it to a standard size. Server feeds the cropped region into a pose-estimation neural network that outputs coordinates of body keypoints (for example, shoulders, elbows, hips, knees, ankles). Server calculates relative positions and angles between keypoints and applies a classification rule set or a small neural classifier to label posture types such as “standing,” “bending,” “climbing,” or “leaning over edge.” The data processing converts image patches into skeletal coordinates and then into posture labels. The output is, for each worker in each frame, a set of keypoint coordinates and an associated posture label with a confidence score.

### Step 5:

Server evaluates protective equipment status.
Server takes as input the detection records from Step 3 and the posture information from Step 4. For each worker, server searches for detections of protective equipment (for example, helmet or safety belt) within a spatial neighborhood around the worker's bounding box. Server applies geometric rules, such as checking whether a helmet bounding box lies above the head keypoints or whether a belt bounding box lies around the torso region. Server marks equipment as “present,” “absent,” or “uncertain” based on detection confidence and spatial consistency. The data processing links worker entities with equipment entities and calculates a Boolean or categorical equipment status per item. The output is an equipment evaluation table specifying, for each worker, the presence or absence of each required protective item.

### Step 6:

Server extracts facial information for emotion analysis.
Server uses worker detections from Step 3 as input. Server runs a face-detection submodule within each worker bounding box to locate face regions. For each detected face, server crops and resizes the face image and normalizes pixel values. Server may enhance contrast or align the face based on eye positions. These operations prepare consistent face images for the emotion classifier. The output is a set of standardized face image tensors with worker IDs and timestamps.

### Step 7:

Server performs facial-based emotion classification.
Server takes the standardized face image tensors from Step 6 as input. Server feeds each tensor into an emotion classification neural network trained to output probabilities for emotion categories (for example, neutral, happy, sad, angry, stressed, fatigued). Inside the network, server applies convolutional and fully connected layers to compute feature embeddings and then a softmax layer to compute class probabilities. Server selects the highest-probability category as the primary facial emotion and retains the full probability vector. The data processing converts visual facial patterns into numeric emotion scores. The output is facial emotion information for each worker and timestamp, including emotion category and probability distribution.

### Step 8:

Server performs voice-based emotion analysis.
Server takes audio segments from Step 1 as input. Server segments each audio stream into analysis windows aligned with the image timestamps. Server computes acoustic features such as Mel-frequency cepstral coefficients, pitch statistics, energy, and speaking rate using a signal-processing library. Server optionally applies speech recognition to obtain transcribed text. Server feeds the acoustic features into a sequence model (for example, a recurrent neural network) to output probabilities for emotion categories. Server may analyze the transcribed text to detect keywords that indicate stress or confusion. The data processing converts raw audio waveforms into acoustic features and then into emotion probabilities. The output is voice-based emotion information for each worker and time window.

### Step 9:

Server fuses facial- and voice-based emotion information.
Server takes as input the facial emotion information from Step 7 and the voice-based emotion information from Step 8, along with worker IDs and timestamps. Server aligns records in time and by worker identity. For each worker and time interval, server combines the two probability vectors using a weighted average or a small fusion network. Server then selects a final emotional state category (for example, calm, anxious, highly stressed, fatigued) and an overall confidence score. The data processing merges multimodal emotion evidence into a single, more robust estimate. The output is consolidated emotion analysis information per worker and timestamp.

### Step 10:

Server constructs analysis information for spatial relations and hazards.
Server uses detections from Step 3, postures from Step 4, and equipment status from Step 5 as input. Server calculates spatial relationships such as distance between workers and hazardous objects (for example, vehicles or edges), overlap with predefined danger zones, and relative movement (for example, approaching or departing). Server represents these relationships as numerical features (for example, distance values, intersection flags, movement vectors). Server organizes the features into structured records per worker and region. The data processing transforms frame-level detections into higher-level spatial context descriptors. The output is analysis information describing worker-hazard relations, posture, and equipment status.

### Step 11:

Server computes a risk index and assigns risk categories.
Server takes analysis information from Step 10 and emotion analysis information from Step 9 as input. For each worker and associated hazard, server forms a feature vector including at least distance to hazard, hazard type, equipment presence flags, posture label, and emotional state code. Server feeds this feature vector into a risk scoring function, which may be a parametric function or a small neural network. Server calculates a scalar risk index between predefined bounds. Server then compares the risk index with threshold values to assign a risk category (for example, low, medium, high, critical). The data processing converts complex multimodal features into a single quantitative risk measure. The output is risk evaluation information for each worker-hazard pair, including risk index and risk category.

### Step 12:

Server builds structured situation description data.
Server uses the risk evaluation information from Step 11 as input. For each situation whose risk category is medium or higher, server creates a situation record containing worker identifier, hazard type, location, equipment status, posture, emotional state, risk index, and risk category. Server stores these records in a structured format such as a table or list, with keys allowing retrieval by worker or time. The data processing aggregates per-frame and per-hazard values into durable situation descriptions. The output is situation description data ready for conversion into natural-language form.

### Step 13:

Server generates a prompt sentence for a generative AI model.
Server takes the situation description data from Step 12 as input. Server selects a text template based on hazard type and risk category, and determines tone and detail level based on emotional state. Server fills placeholders in the template (for example, “hazard type,” “missing equipment,” “emotional state”) with concrete values from the situation description. Server additionally inserts explicit instructions to the generative AI model about tone and structure. The data processing transforms structured fields into a grammatically correct natural-language prompt. The output is a prompt sentence such as: “Danger detected: A construction worker is walking inside a danger zone near moving heavy machinery without wearing a safety helmet. The worker appears calm. Provide concise and direct safety advice that tells the worker what to do immediately.”

### Step 14:

Server invokes the generative AI model with the prompt sentence.
Server uses the prompt sentence from Step 13 as input. Server constructs a request message that includes the prompt sentence and model parameters (for example, maximum output length and randomness level) and sends the request to the generative AI model over a secure communication interface. Server waits for the response and receives generated text tokens, which it decodes into natural-language safety guidance. The data processing sends compact textual prompts rather than raw sensor data, thereby reducing communication bandwidth and focusing the model on relevant context. The output is guidance text that includes safety countermeasure content and, when appropriate, step-by-step work procedures tailored to the encoded emotional state.

### Step 15:

Server post-processes the generated safety guidance information.
Server takes as input the guidance text from Step 14. Server may segment long text into shorter sentences, remove any content that conflicts with site rules, and standardize terminology for equipment and procedures. Server optionally tags the text with emphasis markers for high-priority steps. The data processing filters and normalizes the raw model output into a consistent, deployable format. The output is finalized safety guidance information associated with the originating situation description.

### Step 16:

Server transmits safety guidance information to the terminal.
Server uses the finalized safety guidance information from Step 15 as input. Server encapsulates the guidance in a message including worker ID, risk category, and text content, then sends the message over a network protocol to the corresponding terminal. The data processing converts internal records into a communication payload. The output is a delivered guidance message that arrives at the terminal in near real time.

### Step 17:

Terminal presents safety guidance to the user.
Terminal receives the guidance message from Step 16 as input. Terminal parses the message to extract text and risk category. Terminal renders the text on a display area, using visual formatting such as color coding and icons corresponding to the hazard type. Terminal may invoke a text-to-speech engine to synthesize speech and play the guidance through a speaker or headset, and may generate vibration or audible alerts for high or critical risk categories. The data processing converts received text into multimodal user notifications. The output is a human-perceivable warning and instruction displayed or spoken to the user.

### Step 18:

User provides response information or feedback.
User observes the guidance presented in Step 17 as input to user decision-making. User presses interface buttons such as “Acknowledged,” “Completed,” or “Need help,” or enters spoken or typed comments describing actions taken or questions. The data operation at this step is performed by the user but captured by the terminal as structured response fields (for example, status flag, timestamp, optional comment text). The output is response information encoded in a format suitable for transmission to the server.

### Step 19:

Terminal sends response information back to the server.
Terminal takes the response information from Step 18 as input. Terminal packages the data into a response message containing worker ID, situation ID, response type, and any comment text. Terminal sends this message to the server over the communication network. The data processing on the terminal side transforms user inputs into a normalized, machine-readable record. The output is a response message received by the server.

### Step 20:

Server updates risk evaluation and prompt-generation conditions based on feedback.
Server receives the response message from Step 19 as input. Server links the response to the stored situation description data and marks the associated risk as resolved, ongoing, or escalated based on the response type. Server logs response latency and outcome, and aggregates these statistics over time. Server may adjust parameters in the risk index function (for example, weights for emotional state or equipment absence) if patterns in responses indicate over- or under-sensitivity. Server may also update rules for tone and level of detail in prompt generation (for example, increasing detail for specific hazard types when users frequently select “Need help”). The data processing converts discrete user feedback into parameter updates for internal algorithms. The output is an updated configuration for risk evaluation and prompt-sentence generation that improves future accuracy and relevance of safety guidance.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

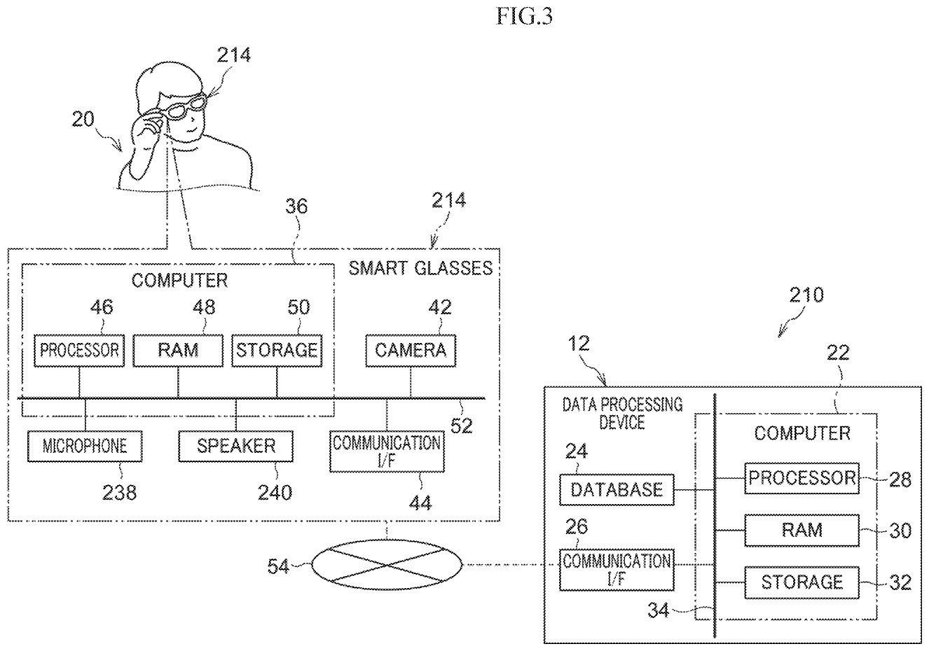

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

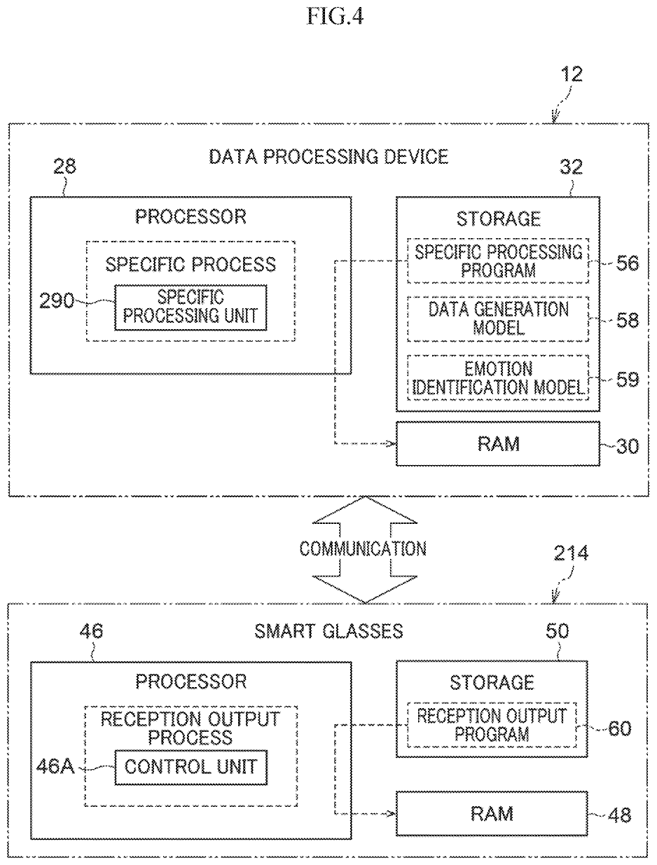

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

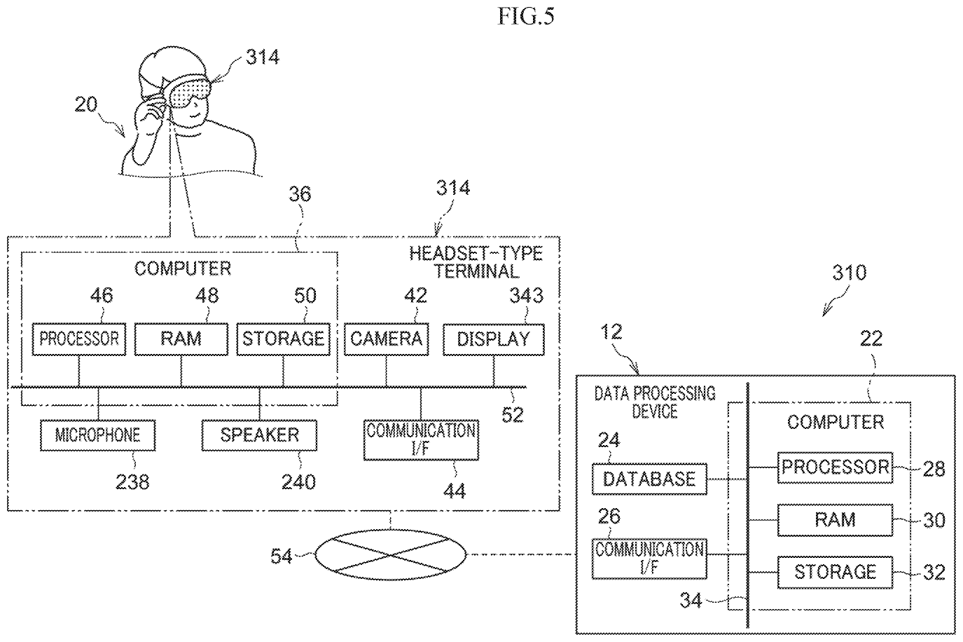

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

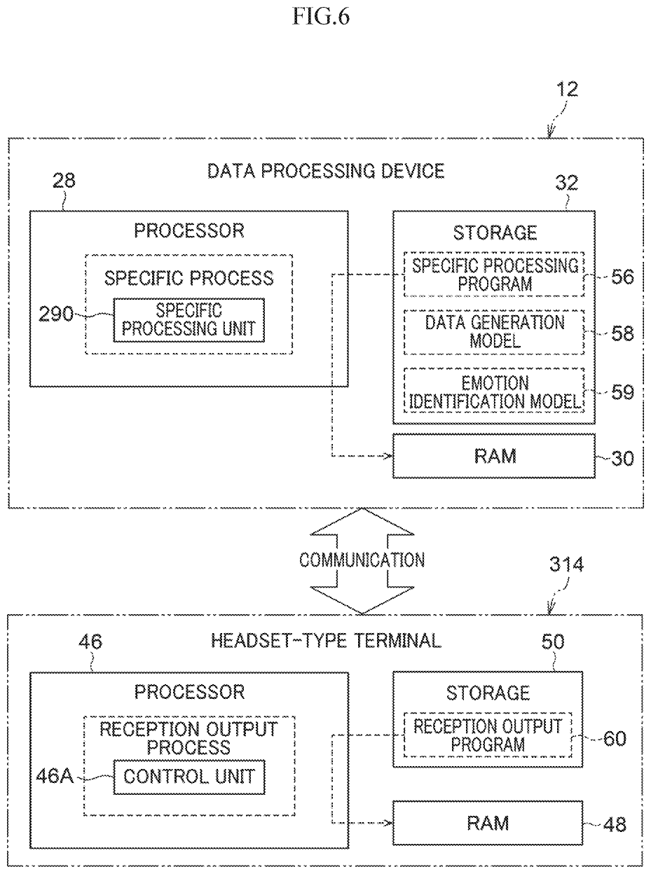

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

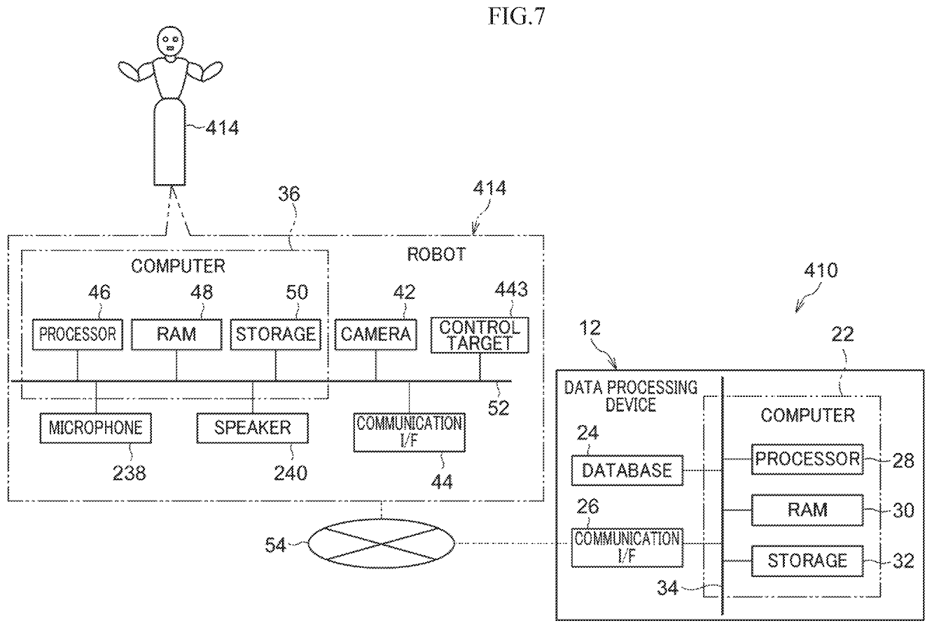

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

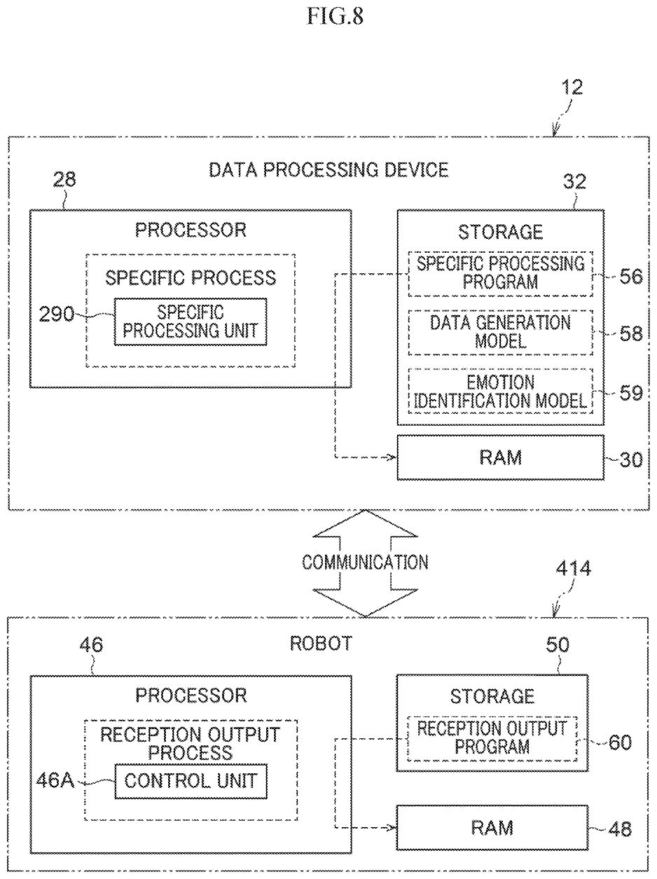

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

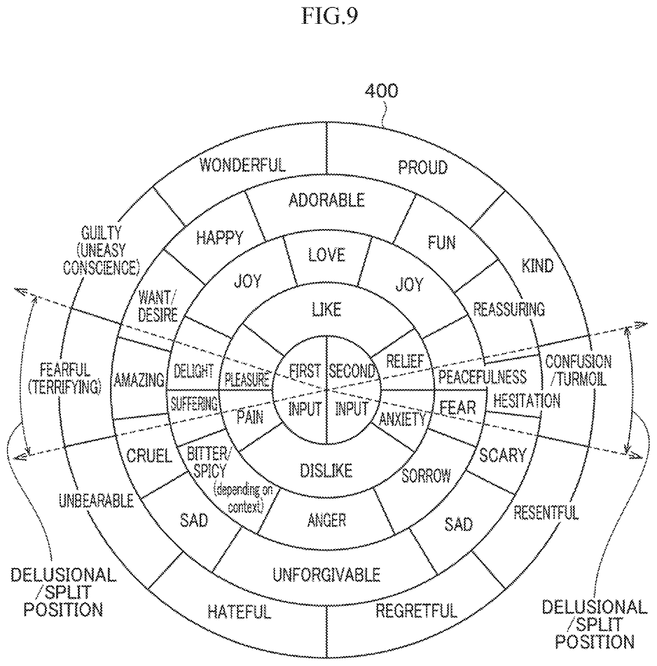

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

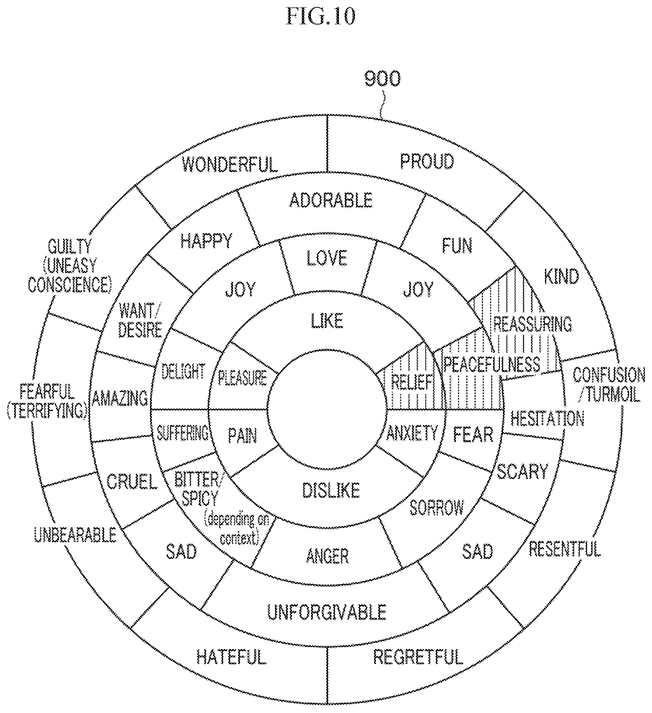

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
control an imaging device that acquires image information of a work area to obtain situation information of the work area, compress the acquired image information, and transmit the compressed image information via a communication network,
receive, via the communication network, the transmitted compressed image information,
decode the compressed image information into an analyzable format, and extract feature information relating to workers and a work environment from the decoded image information,
generate descriptive information indicating candidate dangerous areas and risk factors in the work area on the basis of the extracted feature information, generate a prompt sentence including the descriptive information and predetermined analysis conditions, input the prompt sentence into a generative AI model, and obtain an analysis result relating to dangerous areas and risk levels in the work area from the generative AI model,
identify a dangerous area on the basis of the analysis result, and record dangerous area information including position information, time information, and risk level information associated with the dangerous area, and generate a notification message relating to the dangerous area and reference information indicating a portion of the image information,
transmit the dangerous area information including the notification message to a terminal device or a management device, and cause the terminal device or the management device to present contents of the dangerous area,
generate a prompt sentence including the recorded dangerous area information and state information relating to a worker, input the prompt sentence into the generative AI model to cause the generative AI model to generate guidance content including a countermeasure method for the dangerous area and a work procedure corresponding to the countermeasure method, and obtain the generated guidance content, and
transmit the obtained guidance content to the terminal device or the management device and cause the terminal device or the management device to present the guidance content in accordance with the state information of the worker.

### Supplementary 2

The system according to supplementary 1,
wherein the processor is configured to
cause the extracted feature information to include information relating to a wearing state of protective equipment of the worker and information relating to a work position of the worker recognized from the image information, generate a prompt sentence including the information relating to the wearing state of the protective equipment, the information relating to the work position, and predetermined safety standard information, input the prompt sentence into the generative AI model to obtain an evaluation result as to whether a safety standard is satisfied, and record the evaluation result in association with the dangerous area information.

### Supplementary 3

The system according to supplementary 1,
wherein the processor is configured to
generate a prompt sentence including the dangerous area information, the evaluation result, and information indicating an emotional state or a psychological state of the worker, input the prompt sentence into the generative AI model to cause the generative AI model to generate guidance content including a countermeasure method and a work procedure adjusted in accordance with the emotional state or the psychological state of the worker, determine a portion of the generated guidance content as being suitable for the worker, and cause the terminal device or the management device to present the determined portion.

### Application Example 1

### Supplementary 1

A system comprising a processor,
wherein the processor is configured to
receive image information transmitted from an imaging device that captures a state of a work area via a communication device, and store the image information in a storage device; and
perform object detection processing and region determination processing on the image information in an information processing apparatus by using a machine learning model to detect workers, protective equipment, moving bodies, fall locations, restricted areas, and other targets, specify hazardous regions and hazardous actions based on detection results, and generate structured information indicating the hazardous regions and the hazardous actions; and
generate a prompt sentence by formatting text information including the structured information into an instruction sentence in natural language to be input to a generative artificial intelligence model, and instruct the generative artificial intelligence model to generate safety measures and work procedures; and
acquire advice information in natural language output from the generative artificial intelligence model, format the advice information as guidance information including specific countermeasures and work instructions corresponding to the hazardous regions and the hazardous actions, and notify the guidance information to a portable information terminal device or a visual presentation device; and
acquire response information or inquiry information of a user input from the portable information terminal device or the visual presentation device, generate an additional input prompt sentence including the response information or the inquiry information, guidance information generated in the past, and the structured information, input the additional input prompt sentence to the generative artificial intelligence model, and cause the generative artificial intelligence model to generate guidance information based on the additional input,
wherein the system further comprises a dialogue processing unit configured to execute interactive processing between the user and the generative artificial intelligence model based on the prompt sentences and the guidance information.

### Supplementary 2

The system according to Supplementary 1,
wherein the processor is configured to
evaluate a wearing state of the protective equipment of the workers based on results of the object detection processing, include evaluation information indicating a degree of conformity to a safety standard in the structured information, and change content of instructions for the safety measures in the prompt sentence by using the evaluation information.

### Supplementary 3

The system according to Supplementary 1,
wherein the processor is configured to
change conditions relating to an expression format, a level of detail, and an urgency level of the prompt sentence based on an estimation result relating to a psychological state or a response tendency of the workers included in the advice information output from the generative artificial intelligence model and based on the response information of the user, and
dynamically adjust content and presentation method of the guidance information generated by the generative artificial intelligence model in accordance with a state of the workers.

### Example 2

### Supplementary 1

A system comprising a processor,
wherein the processor is configured to
acquire image information from an imaging apparatus that captures a situation in a work environment, and record the image information in a storage resource,
analyze the image information by executing processing of a trained discrimination model using a computation resource, and specify a dangerous area in the work environment and state information of a worker related to the dangerous area,
generate a prompt sentence by composing, as a natural language input sentence, safety measure content for the dangerous area based on the specified dangerous area and the state information, input the prompt sentence into a generative artificial intelligence model, and cause the generative artificial intelligence model to generate guidance information regarding the safety measure content,
transmit the guidance information generated by the generative artificial intelligence model to a terminal device and cause the terminal device to present the guidance information to a user, and
record, in the storage resource, information on a response result to the dangerous area received from the terminal device, and update at least one of the trained discrimination model and a configuration content of the prompt sentence in accordance with the response result.

### Supplementary 2

The system according to supplementary 1,
wherein the processor is configured to
cause the storage resource to store structured data including equipment state information of the worker and position information concerning the dangerous area, the equipment state information and the position information being extracted from the image information, and
input a prompt sentence embedding the structured data into the generative artificial intelligence model so as to obtain, in parallel, an evaluation result of the equipment state and safety measure content based on the evaluation result.

### Supplementary 3

The system according to supplementary 1,
wherein the processor is configured to
accumulate, in the storage resource, time-series analysis results relating to the dangerous area and the worker and information relating to the response result, adjust an expression format of the prompt sentence and a required output format based on the accumulated information, and cause the generative artificial intelligence model to generate the guidance information as at least one of procedure information, warning information, and educational information.

### Application Example 2

### Supplementary 1

A system comprising a processor,
wherein the processor is configured to
acquire image information and sound information of a work space by using an image acquisition device and a sound acquisition device that capture the work space and output the image information and the sound information,
perform image analysis processing on the image information, the image analysis processing including object detection processing and posture estimation processing, and generate analysis information for identifying a worker, presence or absence of protective equipment, and a danger zone in the work space,
analyze facial information and voice information based on the image information and the sound information, and generate emotion analysis information for estimating an emotional state of the worker,
calculate a risk index for each worker and classify the danger zone into risk categories, based on the analysis information and the emotion analysis information, and generate risk evaluation information,
convert the risk evaluation information into structured situation description data, and generate a prompt sentence in a natural language by embedding the situation description data into the prompt sentence, the prompt sentence being generated such that an expression style and a level of detail of explanation are adjusted in accordance with the emotional state,
input the prompt sentence into a generative information processing model, cause the generative information processing model to generate guidance text including safety countermeasure content and work procedures for the danger zone, and acquire safety guidance information having a tone and explanatory steps that are adapted to the emotional state,
transmit the safety guidance information to a portable information terminal or a display device, and cause the portable information terminal or the display device to notify the worker of the safety guidance information by visual presentation or audio output, and
acquire response information or feedback information from the worker, and update the risk evaluation information and generation conditions of the prompt sentence based on the response information or the feedback information.

### Supplementary 2

### The System According to Supplementary 1,

wherein the processor is configured to
include, in the analysis information, equipment evaluation information indicating an attachment state of the protective equipment of the worker and an item of insufficient equipment, and include, in the prompt sentence, a description that instructs the generative information processing model to generate an indication of a fulfillment state of a safety standard and a corrective action for the insufficient equipment based on the equipment evaluation information.

### Supplementary 3

The system according to supplementary 1,
wherein the processor is configured to
include, in the prompt sentence, information indicating the emotional state of the worker based on the emotion analysis information and instruction information for adjusting, in accordance with the emotional state, politeness of guidance content, an amount of explanation, and a degree of procedural decomposition, and cause the generative information processing model to generate safety countermeasure content adapted to the emotional state of the worker in accordance with the instruction information.

What is claimed is:

1. A system comprising:
circuitry configured to:
receive, via a communication interface coupled to a packet-switched network, compressed image data acquired by an imaging device from a monitored area, and decode the compressed image data into a decompressed image representation;
extract feature data relating to objects and environmental conditions from the decompressed image representation using a feature-extraction algorithm;
generate a first prompt sentence incorporating the extracted feature data and predetermined analysis conditions, input the first prompt sentence to a generative neural network model, and obtain from the generative neural network model a first analysis result comprising area risk data and behavioral pattern data;
identify a candidate risk area based on the first analysis result, and record risk-area data comprising position data, time data, and risk-level data associated with the identified candidate risk area;
generate a notification message based on the risk-area data and transmit the notification message together with reference data indicating a corresponding portion of the image data to a terminal device; and
generate a second prompt sentence incorporating the risk-area data and state data relating to a subject in the monitored area, input the second prompt sentence to the generative neural network model to cause the generative neural network model to generate guidance data comprising a countermeasure procedure and a work procedure corresponding to the countermeasure procedure, and transmit the guidance data to the terminal device.

2. The system according to claim 1, wherein the circuitry is configured to
apply a convolutional neural network to the decompressed image representation to generate a feature map, and extract the feature data from the feature map by applying a pooling operation and a classification layer.

3. The system according to claim 2, wherein the circuitry is configured to
apply an object detection algorithm to the decompressed image representation to generate bounding boxes and confidence scores for detected objects, apply non-maximum suppression to the bounding boxes, and use surviving bounding boxes as input to the feature-extraction algorithm.

4. The system according to claim 3, wherein the circuitry is configured to
generate the first prompt sentence by combining a prompt template with a text representation of the feature data, wherein the prompt template specifies analysis instructions for the generative neural network model including a directive to identify risk levels and behavioral patterns.

5. The system according to claim 4, wherein the circuitry is configured to
classify the first analysis result into a plurality of risk categories based on a risk-level threshold, assign a risk-level identifier to each identified candidate risk area, and store the risk-level identifier together with the position data and the time data in a risk-area record.

6. The system according to claim 1, wherein the circuitry is configured to
generate a third prompt sentence incorporating the risk-area data and state data comprising an emotional state parameter derived from behavioral pattern data of a subject, input the third prompt sentence to the generative neural network model to cause the generative neural network model to generate adjusted guidance data including countermeasure content adjusted based on the emotional state parameter, and transmit the adjusted guidance data to the terminal device.

7. The system according to claim 6, wherein the circuitry is configured to
derive the emotional state parameter by applying an emotional-state estimation model to the behavioral pattern data, classify the emotional state parameter into one of a plurality of emotional state categories, and select a guidance adjustment strategy from a plurality of guidance adjustment strategies based on the classified emotional state category.

8. The system according to claim 7, wherein the circuitry is configured to
generate a fourth prompt sentence incorporating the emotional state parameter and the risk-area data, input the fourth prompt sentence to the generative neural network model to cause the generative neural network model to generate countermeasure content that adjusts procedures and safety measures based on the emotional state parameter, and obtain the countermeasure content as part of the adjusted guidance data.

9. The system according to claim 8, wherein the circuitry is configured to
store, in a memory, a history of emotional state parameters, risk-area data, and guidance data associated with a plurality of time intervals, and supply the history as context data in subsequent prompt sentences to the generative neural network model to adapt guidance generation to observed patterns.

10. The system according to claim 1, wherein the circuitry is configured to
generate a fifth prompt sentence instructing the generative neural network model to evaluate equipment conditions of one or more subjects visible in the decompressed image representation, input the fifth prompt sentence to the generative neural network model, and obtain from the generative neural network model an equipment-evaluation result indicating whether equipment conditions satisfy predetermined safety criteria.

11. The system according to claim 10, wherein the circuitry is configured to
compare the equipment-evaluation result against a plurality of safety criteria stored in a memory, generate a non-compliance notification when at least one safety criterion is not satisfied, and transmit the non-compliance notification to the terminal device together with reference data indicating a corresponding portion of the image data.

12. The system according to claim 11, wherein the circuitry is configured to
generate a remediation prompt sentence incorporating the non-compliance notification and equipment-evaluation result, input the remediation prompt sentence to the generative neural network model to generate corrective procedure data specifying actions for achieving compliance, and transmit the corrective procedure data to the terminal device.

13. The system according to claim 1, wherein the circuitry is configured to
control the imaging device to acquire image data at a predetermined frame rate, apply a compression algorithm to the acquired image data to generate the compressed image data, and transmit the compressed image data to the circuitry via the communication interface using a packet-switched transmission protocol.

14. The system according to claim 13, wherein the circuitry is configured to
apply a background subtraction algorithm to a sequence of decompressed image representations to detect motion regions, restrict the feature-extraction algorithm to the detected motion regions to reduce processing load, and generate the first prompt sentence based on feature data extracted from the motion regions.

15. The system according to claim 1, wherein the circuitry is configured to
generate a risk-area record comprising position data, time data, and risk-level data, transmit the risk-area record to a management device, and cause the management device to render a visual overlay on a map representation indicating the position data and the risk-level data of the identified candidate risk area.

16. The system according to claim 1, wherein the circuitry is configured to
update the risk-area data based on newly received compressed image data to reflect changes in risk levels over time, regenerate the notification message based on the updated risk-area data, and retransmit the updated notification message to the terminal device.

17. The system according to claim 1, wherein the circuitry is configured to
detect a predetermined trigger condition based on the risk-level data, generate an alert message when the trigger condition is satisfied, and transmit the alert message to the terminal device with higher transmission priority than the guidance data.

18. A system comprising:
circuitry configured to:
receive, via a communication interface coupled to a packet-switched network, compressed image data from an imaging device and decode the compressed image data into a decompressed image representation;
apply a convolutional neural network to the decompressed image representation to extract a feature map, and apply an object detection algorithm to the feature map to generate bounding boxes and confidence scores for detected objects;
generate a first prompt sentence incorporating feature data derived from the feature map and a set of analysis instructions, input the first prompt sentence to a generative neural network model, and obtain a first analysis result comprising risk-level data and behavioral pattern data;
identify a risk area from the first analysis result and record risk-area data comprising position data, time data, and risk-level data; and
generate a second prompt sentence incorporating the risk-area data and a state parameter derived from the behavioral pattern data, input the second prompt sentence to the generative neural network model to generate guidance data comprising countermeasure procedures adapted to the state parameter, and transmit the guidance data to a terminal device.

19. The system according to claim 18, wherein the circuitry is configured to
generate a third prompt sentence instructing the generative neural network model to evaluate equipment conditions of subjects visible in the decompressed image representation, obtain an equipment-evaluation result, and transmit a non-compliance notification to the terminal device when the equipment-evaluation result indicates that predetermined safety criteria are not satisfied.

20. A method performed by circuitry, the method comprising:
receiving, via a communication interface coupled to a packet-switched network, compressed image data acquired by an imaging device from a monitored area, and decoding the compressed image data into a decompressed image representation;
extracting feature data relating to objects and environmental conditions from the decompressed image representation using a feature-extraction algorithm;
generating a first prompt sentence incorporating the extracted feature data and predetermined analysis conditions, inputting the first prompt sentence to a generative neural network model, and obtaining from the generative neural network model a first analysis result comprising area risk data and behavioral pattern data;
identifying a candidate risk area based on the first analysis result, and recording risk-area data comprising position data, time data, and risk-level data associated with the identified candidate risk area;
generating a notification message based on the risk-area data and transmitting the notification message together with reference data indicating a corresponding portion of the image data to a terminal device; and
generating a second prompt sentence incorporating the risk-area data and state data relating to a subject in the monitored area, inputting the second prompt sentence to the generative neural network model to cause the generative neural network model to generate guidance data comprising a countermeasure procedure and a work procedure corresponding to the countermeasure procedure, and transmitting the guidance data to the terminal device.
